(19) United States
(12) Patent Application Publication
(10) Pub. No.: US 2026/0044555 A1
(43) Pub. Date: Feb. 12, 2026

(54) MULTI-CHANNEL QUALITY ASSESSMENT AND PROMPT SELECTION TECHNIQUES FOR LARGE LANGUAGE MODELS

(71) Applicant: Optum, Inc., Minnetonka, MN (US)

(72) Inventors: Damian KELLY, Kildare (IE); Vivek BHADAURIA, Bothell, WA (US); Andrey VOLOZIN, Redmond, WA (US); Sanjeeva L. FERNANDO, Cohasset, MA (US); Daksh PEEPAT, Delhi (IN); Kaustav MUKHERJEE, Kolkata (IN); Deepak CHANDRASEKAR, Bengaluru (IN); Seamus S. BRADY, Dublin (IE); Karthick Namakkal KRISHNAN, Tullamore (IE)

(21) Appl. No.: 18/800,252

(22) Filed: Aug. 12, 2024

(51) Int. Cl. G06F 16/35; G06F 16/33; G06F 16/34

(52) U.S. Cl. CPC G06F 16/35; G06F 16/3344; G06F 16/345

(57) ABSTRACT

Various embodiments of the present disclosure provide prompt engineering and text quality assessment techniques for improving generative text outputs. The techniques include identifying a training cluster for an input document, generating a candidate prompt for a generative machine learning model based on the training cluster and a prompt template, providing the candidate prompt to the generative machine learning model to receive at least a portion of a candidate document, generating a plurality of quality metrics for the candidate prompt based on the candidate document, and selecting the candidate prompt from a plurality of candidate prompts based on the plurality of quality metrics.

### BACKGROUND

Various embodiments of the present disclosure address technical challenges related to natural language processing and large language modeling techniques. Traditional large language models (LLMs) are subject to a number of technical challenges including inaccurate hallucinations of text, among others, which limit the reliability of generative text output by such models. In some cases, prompting techniques may be leveraged to guide the generation of text using examples of acceptable outputs. The reliability of such techniques depends on the quality of the prompt provided to a model. The creation of quality prompts is time consuming, expensive, and prone to errors. Moreover, a quality prompt is often case specific making traditional prompting techniques impractical for diverse use cases. Even if done properly, there is a lack of reliable quality assessment techniques for generative text to verify the quality of LLM outputs and/or the prompts for creating the LLM outputs.

Various embodiments of the present disclosure make important contributions to traditional natural language processing and large language modeling techniques by addressing these technical challenges, among others.

### BRIEF SUMMARY

Various embodiments of the present disclosure provide prompt engineering and quality assessment techniques that improve traditional generative text techniques, such as those that leverage LLMs. To do so, some embodiments of the present disclosure provide a generative framework including multiple, iterative multi-stage processes to generate, score, and then select an optimal generative model prompt for a particular generative task. The generative framework may leverage a combination of a multi-stage text matching pipeline, a multi-stage prompt selection pipeline, and multi-channel assessment techniques that jointly enable the automatic (i) creation of candidate prompts directly tailored to a generative task, (ii) creation of refined generative text using the candidate prompts, and (iii) holistic quality assessment of the performance of the candidate prompts. In this way, some of the techniques of the present disclosure enable improved generative text pipelines that directly address technical challenges within the realm of generative modeling, such as inaccurate hallucinations, readability, among others.

In some embodiments, a computer-implemented method comprises identifying, by one or more processors, a training cluster for an input document; generating, by the one or more processors, a candidate prompt for a generative machine learning model based on the training cluster and a prompt template; providing, by the one or more processors, the candidate prompt to the generative machine learning model to receive at least a portion of a candidate document; generating, by the one or more processors, a plurality of quality metrics for the candidate prompt based on the candidate document; and selecting, by the one or more processors, the candidate prompt from a plurality of candidate prompts based on the plurality of quality metrics.

In some embodiments, a computing system comprises memory and one or more processors communicatively coupled to the memory, the one or more processors are configured to identify a training cluster for an input document; generate a candidate prompt for a generative machine learning model based on the training cluster and a prompt template; provide the candidate prompt to the generative machine learning model to receive at least a portion of a candidate document; generate a plurality of quality metrics for the candidate prompt based on the candidate document; and select the candidate prompt from a plurality of candidate prompts based on the plurality of quality metrics.

In some embodiments, one or more non-transitory computer-readable storage media includes instructions that, when executed by one or more processors, cause the one or more processors to identify a training cluster for an input document; generate a candidate prompt for a generative machine learning model based on the training cluster and a prompt template; provide the candidate prompt to the generative machine learning model to receive at least a portion of a candidate document; generate a plurality of quality metrics for the candidate prompt based on the candidate document; and select the candidate prompt from a plurality of candidate prompts based on the plurality of quality metrics.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules for identifying prompting examples for a generative task in accordance with some embodiments discussed herein.

FIG. 5 is a dataflow diagram showing example data structures and modules for selecting a candidate prompt for a generative task in accordance with some embodiments discussed herein.

FIG. 6 is a dataflow diagram showing example data structures and modules for generating multi-channel assessment metrics for a candidate prompt in accordance with some embodiments discussed herein.

FIG. 7 is a flowchart diagram of an example process for selecting a candidate prompt for a generative task in accordance with some embodiments discussed herein.

FIG. 8 is a flowchart diagram of an example process for generating a generative text document in accordance with some embodiments discussed herein.

FIG. 9 is a flowchart diagram of an example process for generating a weighted quality score for a candidate prompt in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

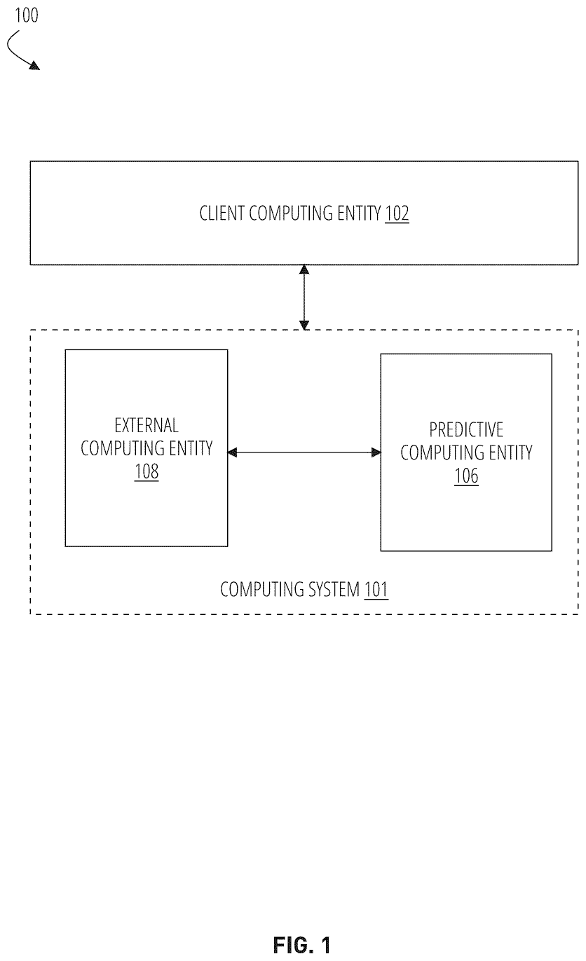

FIG. 1 provides an example overview of an architecture 100 in accordance with some embodiments of the present disclosure. The architecture 100 includes a computing system 101 configured to receive request, such as generative text requests, from client computing entities 102, process the requests to generate generative text outputs, and provide the generated text outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to generate generative text in various forms, include summaries, quality metrics, text segments, refined text segments, controlled text segments, and/or the like. The models may form a machine learning pipeline that may be configured to automatically generate and select an optimal generative model prompt for a particular generative task and then leverage the generative model prompt to perform the generative task. This technique will lead to more accurate and reliable generative text modelling techniques that may be efficiently used for a diverse set of different use cases.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate outputs, such as candidate model prompts, generative text, quality metrics, and/or the like, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., generative text techniques, quality assessment techniques, and/or the like) described herein. The external computing entities 108, for example, may include and/or be associated with one or more entities that may be configured to receive, transmit, store, manage, and/or facilitate datasets, such as the template data store, document template data store, training data store, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

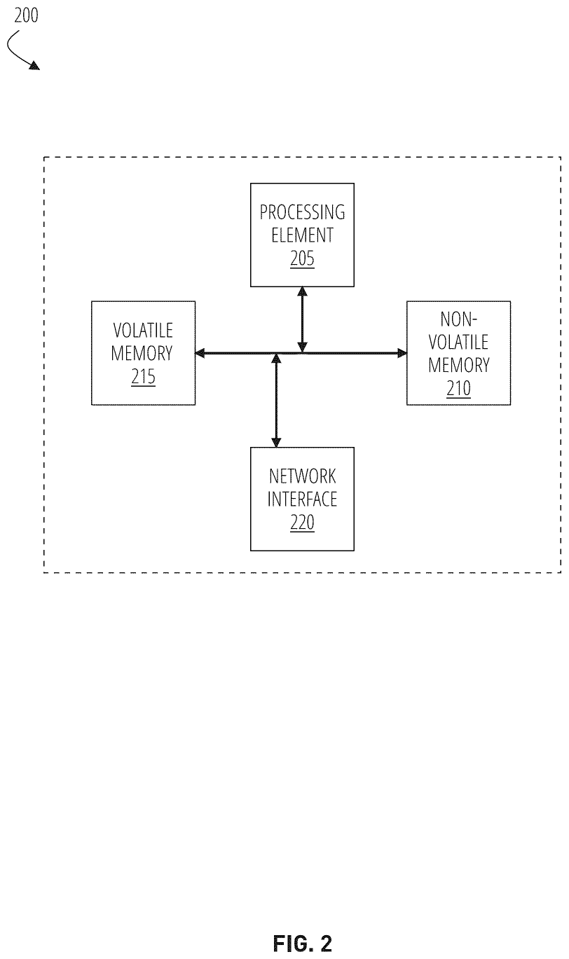

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

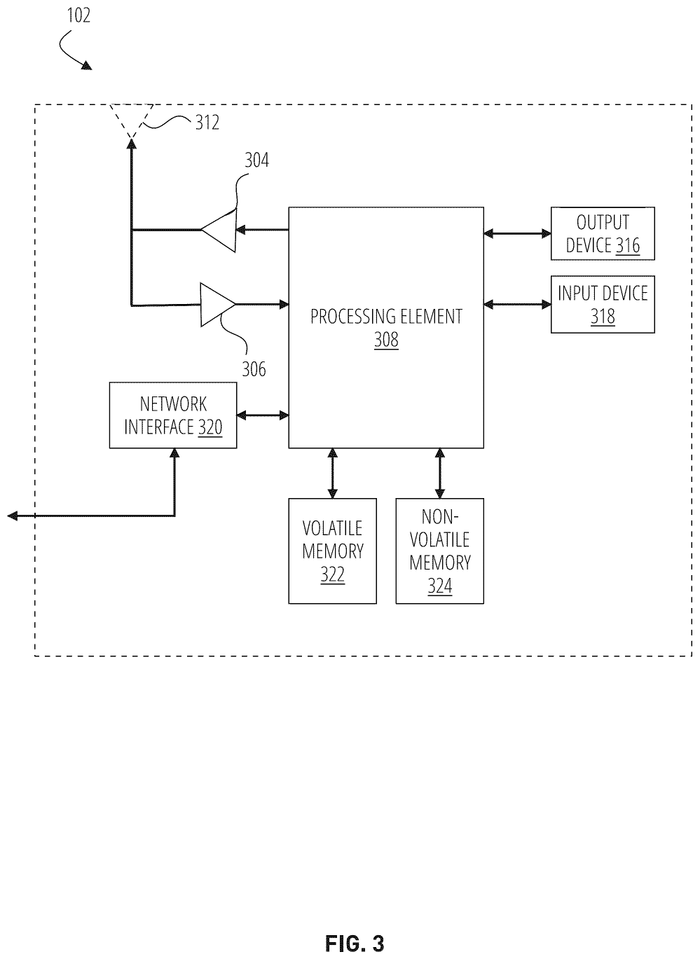

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stercographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “generative text request” refers to a message (e.g., an inter-service message, intra-service message, network message, etc.) that is descriptive of a request to generate a predictive document and/or one or more portions thereof. In some examples, a generative text request may be initiated from a user device using a generative service plug-in. For example, a generative text request may be defined by an application programming interface (API) that is accessible, via the generative service plug-in, from a user interface of the user device. The API may communicatively connect the user device to a computing system configured to process a request to generate a predictive document.

In some embodiments, a generative text request may include a request to generate a predictive document based on an input document. The input document, for example, may include one or more input texts and/or other metadata associated with a topic for a predictive document. For example, the one or more input texts may include one or more request text fields that correspond to one or more controlled fields of a desired predictive document. In some examples, the other metadata may include a topic identifier, a type of generative model options, a requesting user, and/or the like.

In some embodiments, the term “user interface” refers to an interface for a user device for managing one or more historical and/or predictive documents. In some examples, the user interface may include one or more document creation software tools configured to facilitate a creation, modification, and/or evaluation of a predictive document. By way of example, one of the one or more document creation software tools may include a generative service plug-in.

In some embodiments, the term “generative service plug-in” refers to a software component that is configured to facilitate a generative text request. The generative service plug-in, for example, may include one or more portions of computer-readable media that, when executed by one or more processors, is configured to facilitate the generation of a generative text request from a user interface, provide the generative text request to a request tracking interface, and provide a response to the generative text request to the user interface.

In some embodiments, the term “request text fields” refers to a component of a generative text request. A request text field may include a segment of text manually generated for a particular case corresponding to a predictive document. Each request text field, for example, may include natural language text that reflects a portion of a decision for a particular case that corresponds to a controlled field of a predictive document.

As one example using healthcare appeal decision letter for illustration purposes, a desired predictive document may include “Appellant's Argument for Coverage,” “Justification for Decision,” and/or “Final Research” text fields that may be modified on a case-by-case basis. In such a case, the one or more request text fields may include (i) an “Appellant's Argument for Coverage” field including natural language text provided by an Appellant, (ii) a “Justification for Decision” field including natural language text provided by an appeal reviewer in response to the Appellant's arguments, and/or (iii) a “Final Research” field including natural language text to support the justification for a decision.

In some embodiments, the term “training document” refers to a data entity that describes a reference document for predictive document. A training document may include a historical document that is manually created, reviewed, and/or otherwise verified as an exemplary document for a particular topic, scenario, and/or circumstance. Each training document may include a template and/or a plurality of text segments for addressing a particular task in a prediction domain. In some examples, the plurality of text segments may include verified responses for one or more controlled fields. In some examples, each training document may have a respective text segment for each of the one or more controlled fields. In some examples, each training document may have a respective text segment for one or more of the one or more controlled fields.

A training document may include any type of document (e.g., any combination of text segments, templates, subject matter, etc.) and may be tailored to the subject matter of a particular prediction domain. As one example, for a healthcare prediction domain with semi-standardized appeal documentation, a training document may include an appeal decision letter for responding to an appeal, such as a healthcare appeal regarding a medical claim decision. In such a case, the training document may be structured according to a template corresponding to a type of healthcare appeal. The template may include a plurality of controlled fields that each contain information required by a healthcare regulatory authority, such as the Centers for Medicare & Medicaid Services. Moreover, the information provided in each of the controlled fields may be required to be elucidated at a sixth-grade reading level among other requirements designed to ensure a fairness of an appeal process (e.g., whether manually, or automatically completed).

In some embodiments, the term “controlled field” refers to a component of a document (e.g., training, candidate, predictive, etc. document) within a prediction domain that is case specific and subject to one or more standards. A controlled field may include a text segment of a document that is dynamic relative to one or more other static portions (e.g., a template, etc.) of the document.

In some examples, a controlled field may include a predetermined text field for a prediction domain. For example, a controlled field may include a text segment that is designated for a generative text process. The type, number, and/or length of one or more controlled fields may be specific to a prediction domain. As one example, one or more controlled fields for a healthcare, appeal decision scenario may include an “appellant argument,” a “final rationale,” and/or a “final justification.”

In some embodiments, the term “training data store” refers to a data structure that describes data associated with a prediction domain. A training data store may include any type (and any number) of data storage structures including, as examples, one or more linked lists, databases (e.g., relational databases, graph database, etc.), and/or the like.

In some embodiments, a training data store includes a plurality of training entities (e.g., embodied as nodes, data entries, etc.) for a prediction domain. Each training entity may include a training document and/or one or more document attributes. For example, the training data store may include a raw document store with a plurality of historically written (e.g., manually, etc.) and/or generated (e.g., predictive, etc.) training documents. In addition, or alternatively, the training data store may include a refined document store with a plurality of selected training documents. The selected training documents, for example, may be manually selected and/or automatically selected (e.g., using one or more unsupervised clustering techniques to ensure diversity of examples, etc.) using one or more quality metrics, such as those described herein.

In some examples, the training documents may be stored with one or more document attributes. The one or more document attributes may include one or more of: (i) a case identifier, (ii) one or more historical text fields that each include text from a controlled field of the training document, (iii) one or more historical request text fields that each include text from a historical generative text request corresponding to the training document, (iv) one or more document type classifications, (v) one or more contextual classifications corresponding to the training document, (vi) one or more training text summaries corresponding to one or more controlled fields of a training document, (vii) one or more training summary embeddings for the one or more training text summaries, and/or the like.

In some embodiments, the plurality of training documents is organized into one or more training clusters for facilitating a generative text process. The one or more training clusters, for example, may be generated based on one or more training text summaries and/or one or more training summary embeddings respectfully associated with the plurality of training documents.

In some embodiments, the term “training cluster” refers to a data entity that describes a collection of related training documents and/or document segments. A training cluster, for example, may include a subset of the plurality of training documents within the training data store that include one or more related controlled fields. A plurality of training clusters, for example, may include a plurality of spectral clusters generated, using a clustering model, based on the semantic similarities between the controlled fields shared across the plurality of training documents.

In some embodiments, the term “training text summary” refers to a data entity that describes a text segment of a training document. A training text summary may include a summarized portion of text that corresponds to a controlled field of a training document. For example, a training text summary may be generated by extracting a text segment from a training document that corresponds to a controlled field and summarizing the text segment using a large language summarization model. In some examples, a training document may be associated with a plurality of training text summaries. Each training text summary may correspond to a controlled field within the training document. By way of example, for a healthcare, appeal process, a training document may be associated with a respective training text summary for an appellant argument, a final rationale, a final justification, and/or the like.

In some embodiments, the term “large language summarization model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The large language summarization model may include any type of model configured, trained, and/or the like to generate natural language text in response to a textual prompt, such as a summarization model prompt. The large language summarization model, for example, may include an LLM. The large language summarization model may include any type of LLM, such as a generative pre-trained transformer, and/or the like.

In some examples, a document may be provided to a large language summarization model, with a summarization model prompt, to extract one or more text summaries from the document.

In some embodiments, the term “summarization model prompt” refers to a generative model prompt for instructing a large language summarization model to generate a training text summary. In some examples, a summarization model prompt may specify a predefined text threshold (e.g., a summary character limit, etc.) and/or one or more summary attributes. The summary attributes, for example, may define summarization criteria for maintaining precision with respect to a particular controlled field. For example, a summarization model prompt may include a separate prompt for each of one or more controlled fields. Each prompt may define criteria for identifying and summarizing one or more text segments from a document that corresponds to a particular controlled field. In this manner, the summarization model prompt may guide the large language summarization model to generate one or more text summaries for a document.

In some embodiments, the term “training summary embedding” refers to an encoded data entity (e.g., one or more vectors, etc.) that corresponds to a training text summary from a training document. A training summary embedding may include any type of text embedding including Word2Vec embeddings, term frequency-inverse document frequency (TF-IDF) embeddings, bidirectional encoder representations from transformers (BERT) embeddings, and/or the like. In some examples, a training summary embedding may include a Llama embedding (e.g., Llama 7b, etc.).

In some embodiments, the term “machine learning embedding model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning embedding model may include any type of model configured, trained, and/or the like to generate an intermediate output, such as a feature embedding, for a unit of text. A machine learning embedding model may include one or more of any type of machine learning model including one or more supervised, unsupervised, semi-supervised, reinforcement learning models, and/or the like. For instance, a machine learning embedding model may include a bidirectional transformer that may be trained using training data from the training data store to generate one or more domain specific embeddings for a prediction domain.

In some embodiments, the term “machine learning clustering model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning clustering model may include any type of model configured, trained, and/or the like to generate training clusters based on the embedding similarities between a plurality of training summary embeddings. The machine learning clustering model, for example, may include one or more of any type of machine learning model including one or more supervised, unsupervised, semi-supervised, reinforcement learning models, and/or the like. In some examples, a machine learning clustering model may include an unsupervised clustering model, such as a k-means clustering model, hierarchical clustering model, and/or the like.

In some embodiments, the term “input document” refers to a data entity that describes one or more text inputs for generating a predictive document. An input document may include plurality of text segments that may correspond to one or more controlled fields of a prediction domain. By way of example, the input document may include an inference document with one or more request text fields from a generative text request.

In some embodiments, the term “input text summary” refers to a data entity that describes a text segment of an input document. An input text summary may include a summarized portion of text that corresponds to a controlled field of an input document. For example, an input text summary may be generated by extracting a text segment from an input document that corresponds to a controlled field and summarizing the text segment using a large language summarization model. In some examples, an input document may be associated with a plurality of input text summaries. Each input text summary may correspond to a controlled field within the input document. By way of example, for a healthcare, appeal process, an input document may be associated with a respective input text summary for an appellant argument, a final rationale, a final justification, and/or the like.

In some embodiments, the term “input summary embedding” refers to an encoded data entity (e.g., one or more vectors, etc.) that corresponds to an input text summary from an input document. An input summary embedding may include any type of text embedding including Word2Vec embeddings, TF-IDF embeddings, BERT embeddings, and/or the like. In some examples, an input summary embedding may include a Llama embedding (e.g., Llama 7b, etc.).

In some embodiments, the term “prompt training text summary” refers to a training text summary from a training data store that corresponds to an input document. A prompt training text summary, for example, may include a training text summary from the training data store that is associated with one of one or more highest embedding similarities with an input summary embedding from the input document. In some examples, one or more prompt training text summaries may be identified for each input summary embedding associated with an input document.

In some embodiments, a prompt training text summary is identified from a training cluster identified for an input document. For example, a training cluster may be identified by generating a cluster similarity score for each of a plurality of training clusters based on a comparison between (i) one or more input summary embeddings of the input document and (ii) a plurality of training summary embeddings of a subset of training documents within a respective training cluster. For instance, an individual controlled field similarity score may be generated for each controlled field shared by an input document and a training document based on an embedding similarity between an input summary embedding and a training summary embedding corresponding to the controlled field. A cluster similarity score may include an aggregation (e.g., average, etc.) of a plurality of controlled field similarity scores generated for a subset of training documents within a particular training cluster. In some examples, a controlled field similarity score may include a cosine similarity score and the aggregated cluster similarity score may include an average of a plurality of cosine similarity scores for a particular training cluster.

In this manner, once the embeddings are created, a training cluster may be identified from the training data store for which the input summary embeddings belong to using cosine similarity. Once the training cluster is identified, one or more prompt training text sum maries may be extracted from the training cluster for each controlled field of the prediction domain. For example, the top N rows of similarity data may be extracted for each controlled field.

In some embodiments, the term “prompt template” refers to a data entity that describes a predefined structure for a generative model prompt. A prompt template, for example, may include a no-shot prompt template, a few-shot prompt template, and/or the like. The prompt template may include one or more model-specific fields that may be tailored to a particular LLM. In addition, or alternatively, the prompt template may include one or more instruction sets for guiding an LLM for a particular generative task. In some examples, the instruction sets may be dynamically tailored and/or selected for a specific generative task. For instance, a prompt template may be selected from a plurality of prompt templates within a template data store based on an efficacy of the template's instruction set for the specific generative task.

In some embodiments, the term “template data store” refers to a data structure that describes a plurality of candidate prompt templates for a prediction domain. A template data store may include any type (and any number) of data storage structures including, as examples, one or more linked lists, databases (e.g., relational databases, graph database, etc.), and/or the like.

In some embodiments, a template data store may include a plurality of candidate prompt templates, each with a different instruction set for facilitating a generative model output. In some examples, an optimized prompt template may be selected from the template data store for a particular generative task using a voting technique defined by one or more quality assessment techniques of the present disclosure.

In some embodiments, the term “candidate prompt” refers to a data entity that describes a prompt template that is populated by one or more prompt training text summaries. For example, one or more prompt training text summaries identified for an input document, using some of the techniques of the present disclosure, may be combined with a candidate prompt template to generate a candidate prompt. The one or more prompt training text summaries, for example, may be appended as one or more training examples for a generative machine learning model. By way of example, once the top N rows of prompt training text summaries are identified, they may be combined with a suitable prompt retrieved from a template data store to build a prompt for generating a text for a predictive document via a generative machine learning model.

In some embodiments, the term “generative machine learning model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A generative machine learning model may include any type of model configured, trained, and/or the like to generate natural language text in response to a textual prompt, such as a candidate prompt, as described herein. For example, the generative machine learning model may include a generative pre-trained transformer (GPT) model.

In some examples, a candidate prompt may be provided to a generative machine learning model to generate one or more candidate text fields for a candidate document.

In some embodiments, the term “candidate text field” refers to a component of a candidate document. A candidate text field, for example, may include a text segment for a controlled field of a candidate document. For instance, a candidate text field may include natural language text output from a generative machine learning model in response to a candidate prompt. For instance, a candidate prompt may be passed to a few-shot trainer module, where the generative machine learning model may generate text in accordance with the candidate prompt. In some examples, a separate candidate prompt may be generated for each controlled field in a candidate document and a candidate text field may be individually generated by the generative machine learning model, in accordance with the separate candidate prompts, for each of the controlled fields.

In some embodiments, the term “hallucination mitigation model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A hallucination mitigation model may include any type of model configured, trained, and/or the like to filter natural language text in response to a textual prompt, such as a hallucination mitigation prompt, as described herein. For example, the hallucination mitigation model may include a GPT model trained to detect and filter hallucinations from natural language text generated by a generative machine learning model. For example, for hallucination removal, synthetic document examples may be leveraged which will serve as contrastive learning samples within a hallucination mitigation prompt.

In some embodiments, the term “hallucination mitigated candidate text field” refers to a processed candidate text field that is previously processed to filter hallucinated text from the candidate text field. For example, candidate text fields may be passed to the hallucination mitigation model to remove hallucination from the candidate text fields. In this manner, anomalous generative text output by a generative machine learning model may be identified and removed to clean the generative text segments.

In some embodiments, the term “hallucination mitigation prompt” refers to a generative model prompt for instructing a hallucination mitigation model to filter hallucinations from a generative text segment, such as a candidate text field. In some examples, a hallucination mitigation prompt may include one or more synthetic examples of hallucinated context and/or a contextual prompt for instructing the identification and removal of hallucination context from an input generative text segment based on the one or more synthetic examples. By way of example, a hallucination mitigation prompt for a healthcare prediction domain may include:

{″role″: ″system″, ″content″:″ You are an assistant that validates Health
Insurance Appeal decisions that are sent to clients by looking at the
provided examples. ″
″Try to see if all the information in the Concern field is relevant to the
information provided in the field Appeal Argument, Denial Rationale and
Claim”.
″If any irrelevant information is there, remove the irrelevant information &
re-phrase the Concern.″
}
{″role”:” user″,
“Content”:
Provider: provider1
Claim: claim1
Denial Rationale: denial_rationale1
Appeal Argument: appeal_argument1
Concerns:
}
{″role”:” assistant″,
Concern removing irrelevant information/hallucinations.
}

In some embodiments, the term “candidate document template” refers to a data entity that describes a predefined structure for a candidate document. A candidate document template, for example, may include one or more static and/or dynamic text segments that are structured according to a specific document format. The static text segments may include contextual information that universally applies to a type of candidate document. The dynamic text segments may be specific to a particular candidate document. The dynamic text segments, for example, may include rule-based information that may be populated using one or more rule-based techniques (e.g., a date formatter, etc.). In addition, or alternatively, the dynamic text segments may include one or more controlled fields that apply to a particular type of candidate document. In some examples, the one or more controlled fields may be populated with candidate text fields generated using one or more techniques of the present disclosure.

In some embodiments, the term “candidate document” refers to a document that describes a particular case corresponding to an input document. A candidate document, for example, may include a candidate document template that is populated with a plurality of candidate text fields. For example, after the candidate text fields are generated, the candidate text fields may be passed to a letter formatter, which may identify a candidate document template, from a document template data store, that corresponds to the set of generated candidate text fields. Once identified, the candidate document template may be populated with the candidate text fields to generate a candidate document.

In some embodiments, the term “quality metric” refers to a quality measure that describes a particular aspect of a candidate prompt. For example, once a candidate document is generated using a candidate prompt, the candidate document may be leveraged to generate a plurality of quality metrics that may be correlative to an efficacy of the candidate prompt. The quality metrics, for example, may each be tailored to a goal aspect of a predictive document. In this manner, different quality measures for a candidate document may by leveraged to assess the efficacy of a candidate prompt across a plurality of different assessment channels. In some examples, a quality metric may include a sub-component of a weighted quality score that aggregates quality scores across the plurality of different assessment channels. By way of example, a quality metric may include one or more multi-prompt-based assessment metrics, one or more string-based assessment metrics, and/or one or more embedding-based assessment metrics that may be aggregated to generate a holistic quality score for a candidate document that may be attributed back to a corresponding candidate prompt.

In some embodiments, the term “multi-prompt-based assessment metric” refers to a type of quality metric that is reflective is of a natural language quality of a document. A multi-prompt-based assessment metric, for example, may be reflective of one or more human-based metrics for a document. By way of example, the multi-prompt-based assessment metric may include an aggregation of a plurality of generative scores that respectively judge a quality of a document based on subjective measures, such as a fluency, coherency, informativeness, relevance, and/or the like of a document. Each of the generative scores may be generated using an assessment prompt that includes a contextual prompt and/or one or more examples for assessing a particular subjective quality of a document.

In some embodiments, the multi-prompt-based assessment metric includes a weighted aggregate of a plurality of generative scores, including a fluency score, a relevancy score, an informativeness score, and/or a coherency score. In some examples, the weights may be learned over time based on one or more annotated labels for predictive documents. The labels, for example, may include a ground truth multi-prompt-based assessment metric for a training predictive document and one or more corresponding generative scores. In some examples, the weights may be at least initially set. As one example, the multi-prompt-based assessment metric may be defined as:

$$Avg\_metric = ( Coherency score * 0.2 + Relevancy score * 0.2 + Fluency score * 0.1 + Informativeness score * 0. 5 )$$

In some embodiments, a fluency score is generated, using an assessment LLM, based on a fluency prompt. By way of example, the fluency score may be generated using a prompt-based document assessment by providing a document and the fluency prompt to the assessment LLM. An example, fluency prompt may be defined as follows:
Score the following [task-ins] with respect to [aspect] on a continuous scale from 0 to 100, where a score of zero means “[ant-aspect]” and score of one hundred means “perfect [aspect]”. Note that [aspect] measures [Fluency].
[Generated Text]
Human reference: [A Reference]
Scores:

In some examples, the fluency prompt may include a plurality of annotated examples (e.g., human references, etc.) for instructing the LLM to assess a fluency of a document.

In some embodiments, a relevancy score is generated, using an assessment LLM, based on a relevancy prompt. By way of example, the relevancy score may be generated using a prompt-based document assessment by providing a document and the relevancy prompt to the assessment LLM. An example, relevancy prompt may be defined as follows:
Score the following [task-ins] with respect to [aspect] on a continuous scale from 0 to 100, where a score of zero means “[ant-aspect]” and score of one hundred means “perfect [aspect]”. Note that [aspect] measures [Relevance].
[Generated Text]
Human reference: [A Reference]

In some examples, the relevancy prompt may include a plurality of annotated examples (e.g., human references, etc.) for instructing the LLM to assess a relevancy of a document.

In some embodiments, an informativeness score is generated, using an assessment LLM, based on an informative prompt. By way of example, the informativeness score may be generated using a prompt-based document assessment by providing a document and the informative prompt to the assessment LLM. An example, informative prompt may be defined as follows:
Score the following [task-ins] with respect to [aspect] on a continuous scale from 0 to 100, where a score of zero means “[ant-aspect]” and score of one hundred means “perfect [aspect]”. Note that [aspect] measures
[Informativeness].
[Generated Text]
Human reference: [A Reference]
Scores:

In some examples, the informativeness prompt may include a plurality of annotated examples (e.g., human references, etc.) for instructing the LLM to assess an informativeness of a document. In addition, or alternatively, the informativeness prompt may include a ground truth document (e.g., training document) for assessing an informativeness of a document relative to the ground truth document.

In some embodiments, a coherency score is generated, using an assessment LLM, based on a coherency prompt. By way of example, the coherency score may be generated using a prompt-based document assessment by providing a document and the coherency prompt to the assessment LLM. An example, coherency prompt may be defined as follows:
Score the following [task-ins] with respect to [aspect] on a continuous scale from 0 to 100, where a score of zero means “[ant-aspect]” and score of one hundred means “perfect [aspect]”. Note that [aspect] measures [Coherence].
[Generated Text]
Human reference: [A Reference]
Scores:

In some examples, the coherency prompt may include a plurality of annotated examples (e.g., human references, etc.) for instructing the LLM to assess a coherency of a document.

In some embodiments, the term “string-based distance metric” refers to a type of quality metric that is reflective of a syntactic quality of a document. A string-based distance metric, for example, may be reflective of a document syntactic similarity to a ground truth document (e.g., a training document, etc.). For example, a string-based distance metric may include a Levenshtein distance. The Levenshtein distance, for example, may include a measure of a difference between two strings of characters, defined as the minimum number of single-character edits (insertions, deletions, or substitutions) required to transform one string into the other. In the context of generative text quality, the Levenshtein distance may be used to evaluate how syntactically similar a document is to a training document.

In some examples, the string-based distance metric may include the Levenshtein distance combined with a sematic measure, such as a cosine distance between a document and a training document. For example, the string-based distance metric may include a weighted distance, which takes an equal proportion of the Levenshtein and cosine distances and passes it to a neural network approximator function, which may convert the distance into the string-based distance metric.

In some embodiments, the term “embedding-based distance metric” refers to a type of quality metric that is reflective of a semantic quality of a document. An embedding-based distance metric, for example, may be reflective of a document semantic similarity to a ground truth document (e.g., a training document, etc.). For example, an embedding-based distance metric may include a modified cosine distance. The cosine distance may include a measure of the similarity between two vectors in a high-dimensional space. In the context of generative text quality, the cosine distance may be used to evaluate how semantically similar a document is to a training document based on semantic and/or contextual information rather than syntactic differences between texts. In some examples, the embedding-based distance metric may include a cosine distance between llama-based embeddings of the document and a training document. In some examples, the cosine distance may be discretized into one or more buckets (e.g., on a scale 1-5) to generate the embedding-based distance metric.

In some embodiments, the term “weighted quality score” refers to an aggregated quality score for a candidate prompt. For example, a weighted quality score may include an aggregation of the multi-prompt-based assessment metric, the string-based distance metric, and/or the embedding-based distance metric. In some examples, the weighted quality score may include an average of the quality metrics. In addition, or alternatively, the weighted quality score may include a weighted average of the quality metrics. In some examples, the weighted average may be learned over time using one or more annotated training documents. In some examples, a candidate prompt associated with a best weighted average score may be selected to generate a predictive document for an input document.

In some embodiments, the term “predictive document” refers to a document with a plurality of a generative text fields. The plurality of generative text fields, for example, may each be generated using a generative machine learning model and a candidate prompt selected using one or more techniques of the present disclosure. For example, using one or more techniques of the present disclosure, a few-shot prompt may be designed for each dynamic text field of a candidate document template and the candidate document template may be populated, with generative text fields output using the few-shot prompts, to generate a predictive document. In some embodiments, the predictive document may be provided to a human for manual review and once accepted, may be added as a training document for future prompt designs. In this manner, the techniques of the present disclosure may continuously adapt to new circumstances as they arise within a prediction domain.

### IV. Overview

Various embodiments of the present disclosure provide prompt engineering and quality assessment techniques that improve traditional generative text techniques, such as those that leverage LLMs. To do so, some embodiments of the present disclosure provide a generative framework including multiple, iterative multi-stage processes to generate, score, and then select an optimal generative model prompt for a particular generative task. To do so, the generative framework may leverage a combination of a multi-stage text matching pipeline, a multi-stage prompt selection pipeline, and multi-channel assessment techniques that jointly enable the automatic (i) creation of candidate prompts directly tailored to a generative task, (ii) creation of refined generative text using the candidate prompts, and (iii) holistic quality assessment of the performance of the candidate prompts. Individually, each of these techniques improve various aspects of traditional prompt engineering and quality assessment techniques. Together, they may be leveraged to select optimal prompts for an LLM to improve upon traditional large language modeling techniques. This, in turn, enables an improved generative text pipeline that directly addresses technical challenges within the realm of generative modeling, such as inaccurate hallucinations, readability, processing and memory requirements, among others.

In various embodiments, some of the techniques of the present disclosure provide a multi-stage text matching pipeline that enables improved generative model prompts for a generative task. Traditional generative techniques for creating a controlled document (e.g., a document that is subject to one or more constraints, such as a reading level requirement, etc.) allow for the creation of a template, but still rely on place holders that must be manually filled to complete the document. These place holders are traditionally necessary to ensure that the controlled documents comply with various controlling rules and because the processing, time, and memory resources required to individually craft generative model prompts reduces the practicality of using generative models for such tasks. The multi-stage text matching pipeline of the present disclosure overcomes these technical challenges by translating historical documentation into specific texts that may replace manual text with sufficient accuracy and reliability to be practically applied at scale. To do so, the multi-stage text matching pipeline generates a plurality of training clusters, using a clustering model, that may be matched to an input document with sample text for a controlled document. Once matched, a plurality of historical examples may be sampled from the training cluster to generate a generative model prompt with sufficient examples to accommodate various controlling rules that constrain the format, content, and other aspects of a controlling document. In this way, the multi-stage text matching pipeline may improve upon traditional generative text modeling techniques by reliably automating the generation of controlled documents through the generation of comprehensive generative model prompts. Moreover, by first matching to a training cluster, before sampling examples for the generative model prompt, the multi-stage text matching pipeline reduces the processing time and memory resources required to generation highly targeted generative model prompts. This, in turn, provides a practical approach to automated prompt engineering techniques that have traditionally consumed exorbitant resources preventing their use at scale.

In various embodiments, some of the techniques of the present disclosure provide a multi-stage prompt selection pipeline that enables the optimization of generative model prompts for a generative task. Due to the complexities of machine learning generative models, prompt engineering techniques traditionally rely on manual case studies and trial and error to build an effective prompt for a particular use case. Even with a set of comprehensive examples, an efficient prompt template is necessary to optimize the performance of a generative model. The efficacy of prompt templates, however, may vary drastically depending on a generative task. The time and effort to match an optimal prompt template to each and every type of generative task limits the practicality of applying generative models to prediction domains with diverse use cases. The multi-stage prompt selection pipeline of the present disclosure improves upon traditional prompt engineering techniques by iteratively generating, scoring, and then ultimately selecting a candidate prompt in an automated pipeline designed to automatically uncover the most effective prompt for a particular use case. By doing so, the multi-stage prompt selection pipeline improves the robustness and adaptability of traditional generative modeling techniques and enables the generation of on-the-fly, application-specific generative model prompts for a diverse and continuously changing set of use cases.

In various embodiments, some of the techniques of the present disclosure provide multi-channel assessment techniques that enable a holistic evaluation of a generative model prompt. Traditionally, the assessment of text is a manual process due to the subjective nature of the quality assessment task. While alternative metrics exist, these metrics are limited to specific facets of text and fail to provide a comprehensive substitute for a human quality rating. The requirement for human input significantly reduces the applicability of generative text techniques to small, individualized use cases. Using some of the techniques of the present disclosure, the applicability of generative text techniques may be expanded to large use cases without reducing the quality of generative text outputs by simulating a subjective metrics for generative text using quality assessment prompts tailored to a specific subjective measure. Using some of the techniques of the present disclosure, these subjective metrics may be grounded with other traditional metrics to create a holistic quality score for evaluating generative text. The holistic score for the generative text may be mapped back to a prompt responsible for generating the text to understand an efficacy of a generative model prompt. By doing so, a plurality of generative model prompts may be scored and evaluated against one another to identify an optimal prompt for a particular generative task. In this way, the multi-channel assessment techniques of the present disclosure may enable the holistic evaluation of a generative model prompt, which, in turn, enables the automated selection of an optimal model prompt for a diverse array of different generative tasks.

Examples of technologically advantageous embodiments of the present disclosure include: (i) prompt engineering techniques for automatically generating generative model prompts and (ii) prompt quality assessment techniques for assessing the quality of a generative model prompt, among other aspects of the present disclosure. Other technical improvements and advantages may be realized by one of ordinary skill in the art.

### V. Example System Operations

As indicated, various embodiments of the present disclosure make important technical contributions to generative text techniques. In particular, systems and methods are disclosed herein that implement prompt engineering and quality assessment techniques to improve machine learning model performance with respect to text generation tasks. By doing so, generative text models may be improved to expand the applicability of generative text techniques to diverse and controlled use cases. This, in turn, may enable the use of generative text models for controlled documentation that is traditionally outside the scope of such models.

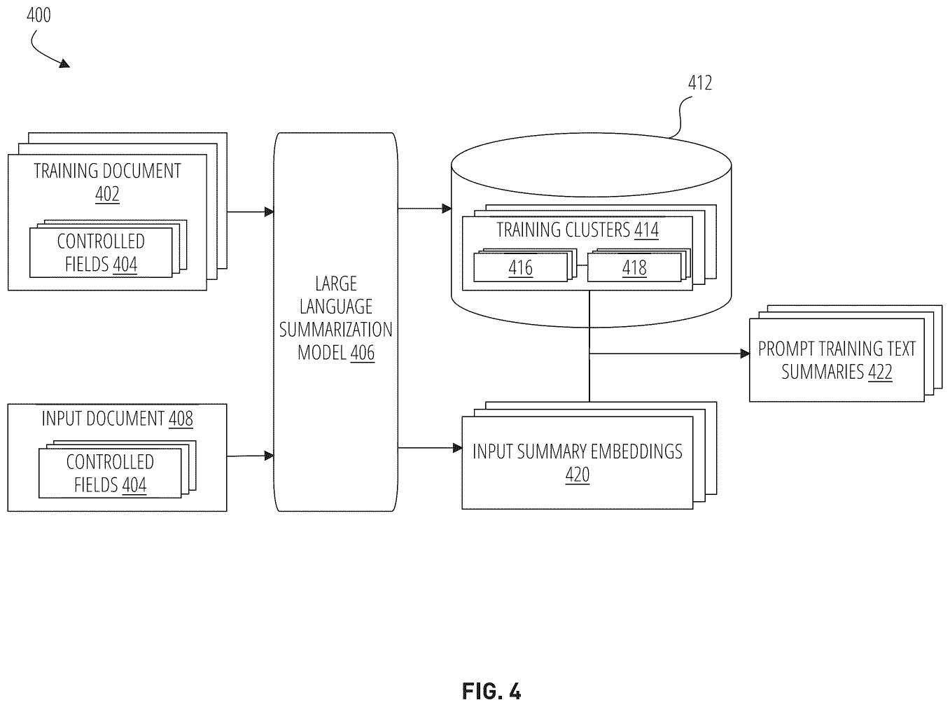

FIG. 4 is a dataflow diagram 400 showing example data structures and modules for identifying prompting examples for a generative task in accordance with some embodiments discussed herein. The dataflow diagram 400, for example, illustrates a multi-stage text matching pipeline for intelligently identifying one or more prompt training text summaries 422 from a training data store 412 that are tailored to a particular input document 408. In some examples, the prompt training text summaries 422 may be identified for each of one or more controlled fields 404 shared by a plurality of training documents 402 and the input document 408. For example, as described herein, in a first stage of the multi-stage text matching pipeline, a training cluster may be identified for an input document 408 based on a similarity across all of the controlled fields 404. In a second stage of the multi-stage text matching pipeline, one or more different prompt training text summaries 422 are identified from the training cluster for each of the controlled fields 404. In this way, individual text segments may be identified from a subset of training documents 402 that prefiltered based on their holistic similarity to an input document 408. By doing so, the multi-stage text matching pipeline improves upon traditional prompt generation techniques by surfacing relevant prompt examples for a segment of text that are grounded by an overall context in which the segment of text may be placed. This allows for improved, template-based, generative text tasks among other technical advancements described herein.

In some embodiments, a training cluster is identified for an input document 408 from a plurality of training clusters 414. The training cluster may include a subset of a plurality of training documents 402 for a prediction domain. In some examples, the training cluster may be previously generated in an offline segmentation process in which the training data store 412 is populated with a plurality of training documents. In some examples, the training data store 412 is continuously updated using some of the techniques of the present disclosure.

In some embodiments, a plurality of training text summaries 416 is generated for the plurality of training documents 402. The training text summary 416, for example, may be generated using a large language summarization model 406. In some examples, the training text summary 416 may be generated based on one or more controlled fields 404 for a prediction domain.

In some embodiments, the training document 402 is a data entity that describes a reference document for predictive document. A training document 402 may include a historical document that is manually created, reviewed, and/or otherwise verified as an exemplary document for a particular topic, scenario, and/or circumstance. Each training document 402 may include a template and/or a plurality of text segments for addressing a particular task in a prediction domain. In some examples, the plurality of text segments may include verified responses for one or more controlled fields 404. In some examples, each training document 402 may have a respective text segment for each of the one or more controlled fields. In some examples, each training document may have a respective text segment for one or more of the one or more controlled fields 404.

A training document 402 may include any type of document (e.g., any combination of text segments, templates, subject matter, etc.) and may be tailored to the subject matter of a particular prediction domain. As one example, for a healthcare prediction domain with semi-standardized appeal documentation, a training document 402 may include an appeal decision letter for responding to an appeal, such as a healthcare appeal regarding a medical claim decision. In such a case, the training document 402 may be structured according to a template corresponding to a type of healthcare appeal. The template may include a plurality of controlled fields 404 that each contain information required by a healthcare regulatory authority, such as the Centers for Medicare & Medicaid Services. Moreover, the information provided in each of the controlled fields 404 may be required to be elucidated at a sixth-grade reading level among other requirements designed to ensure a fairness of an appeal process (e.g., whether manually, or automatically completed).

In some embodiments, a controlled field 404 is a component of a document (e.g., training, candidate, predictive, etc. document) within a prediction domain that is case specific and subject to one or more standards. A controlled field 404 may include a text segment of a document that is dynamic relative to one or more other static portions (e.g., a template, etc.) of the document.

In some examples, a controlled field 404 may include a predetermined text field for a prediction domain. For example, a controlled field 404 may include a text segment that is designated for a generative text process. The type, number, and/or length of one or more controlled fields 404 may be specific to a prediction domain. As one example, one or more controlled fields 404 for a healthcare, appeal decision scenario may include an “appellant argument,” a “final rationale,” and/or a “final justification.”

In some embodiments, the training text summary 416 is a data entity that describes a text segment of the training document 402. The training text summary 416 may include a summarized portion of text that corresponds to a controlled field 404 of the training document 402. For example, a training text summary 416 may be generated by extracting a text segment from a training document 402 that corresponds to a controlled field 404 and summarizing the text segment using a large language summarization model 406. In some examples, the training document 402 may be associated with a plurality of training text summaries 416. Each training text summary 416 may correspond to a different controlled field 404 within the training document 402. By way of example, for a healthcare, appeal process, a training document 402 may be associated with a respective training text summary 416 for an appellant argument, a final rationale, a final justification, and/or the like.

In some embodiments, the large language summarization model 406 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The large language summarization model 406 may include any type of model configured, trained, and/or the like to generate natural language text in response to a textual prompt, such as a summarization model prompt. The large language summarization model 406, for example, may include an LLM. The large language summarization model 406 may include any type of LLM, such as a generative pre-trained transformer, and/or the like.

In some examples, a document may be provided to a large language summarization model 406, with a summarization model prompt, to extract one or more text summaries from the document.

In some embodiments, the summarization model prompt is a generative model prompt for instructing the large language summarization model 406 to generate a training text summary 416. In some examples, a summarization model prompt may specify a predefined text threshold (e.g., a summary character limit, etc.) and/or one or more summary attributes. The summary attributes, for example, may define summarization criteria for maintaining precision with respect to a particular controlled field 404. For example, a summarization model prompt may include a separate prompt for each of one or more controlled fields 404. Each prompt may define criteria for identifying and summarizing one or more text segments from a document that corresponds to a particular controlled field 404. In this manner, the summarization model prompt may guide the large language summarization model 406 to generate one or more text summaries for a document.

In some embodiments, a plurality of training summary embeddings 418 is generated for the plurality of training text summaries 416. The plurality of training summary embedding 418, for example, may be generated using a machine learning embedding model.

In some embodiments, the training summary embedding 418 is an encoded data entity (e.g., one or more vectors, etc.) that corresponds to a training text summary 416 from a training document 402. The training summary embedding 418 may include any type of text embedding including Word2Vec embeddings, TF-IDF embeddings, BERT embeddings, and/or the like. In some examples, the training summary embedding 418 may include a Llama embedding (e.g., Llama 7b, etc.).

In some embodiments, the machine learning embedding model is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning embedding model may include any type of model configured, trained, and/or the like to generate an intermediate output, such as a feature embedding, for a unit of text. A machine learning embedding model may include one or more of any type of machine learning model including one or more supervised, unsupervised, semi-supervised, reinforcement learning models, and/or the like. For instance, the machine learning embedding model may include a bidirectional transformer that may be trained using training data from the training data store 412 to generate one or more domain specific embeddings for a prediction domain.

In some embodiments, the training data store 412 is a data structure that describes data associated with a prediction domain. The training data store 412 may include any type (and/or any number) of data storage structures including, as examples, one or more linked lists, databases (e.g., relational databases, graph database, etc.), and/or the like.

In some embodiments, the training data store 412 includes a plurality of training entities (e.g., embodied as nodes, data entries, etc.) for a prediction domain. Each training entity may include a training document 402 and/or one or more document attributes. For example, the training data store 412 may include a raw document store with a plurality of historically written (e.g., manually, etc.) and/or generated (e.g., predictive, etc.) training documents 402. In addition, or alternatively, the training data store 412 may include a refined document store with a plurality of selected training documents. The selected training documents, for example, may be manually selected and/or automatically selected (e.g., using one or more unsupervised clustering techniques to ensure diversity of examples, etc.) using one or more quality metrics, such as those described herein.

In some examples, the training documents 402 may be stored with one or more document attributes. The one or more document attributes may include one or more of: (i) a case identifier, (ii) one or more historical text fields that each include text from a controlled field 404 of the training document 402, (iii) one or more historical request text fields that each include text from a historical generative text request corresponding to the training document 402, (iv) one or more document type classifications, (v) one or more contextual classifications corresponding to the training document 402, (vi) one or more training text summaries 416 corresponding to one or more controlled fields 404 of a training document 402, (vii) one or more training summary embeddings 418 for the one or more training text summaries 416, and/or the like.

In some embodiments, the plurality of training documents 402 is organized into one or more training clusters 414 for facilitating a generative text process. The one or more training clusters 414, for example, may be generated based on one or more training text summaries 416 and/or one or more training summary embeddings 418 respectfully associated with the plurality of training documents 402.

In some embodiments, a subset of the plurality of training documents 402 is identified for a training cluster. The subset of the plurality of training documents 402 may be identified, for example, using a machine learning clustering model.

In some embodiments, the training cluster is a data entity that describes a collection of related training documents and/or document segments. A training cluster, for example, may include a subset of the plurality of training documents 402 within the training data store 412 that include one or more related controlled fields. A plurality of training clusters 414, for example, may include a plurality of spectral clusters generated, using a clustering model, based on the semantic similarities between the controlled fields shared across the plurality of training documents 402.

In some embodiments, the machine learning clustering model is a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning clustering model may include any type of model configured, trained, and/or the like to generate training clusters 414 based on the embedding similarities between a plurality of training summary embeddings 418. The machine learning clustering model, for example, may include one or more of any type of machine learning model including one or more supervised, unsupervised, semi-supervised, reinforcement learning models, and/or the like. In some examples, the machine learning clustering model may include an unsupervised clustering model, such as a k-means clustering model, hierarchical clustering model, and/or the like.

In some embodiments, the training cluster is identified based on one or more embeddings from an input document 408. An input document 408, for example, may include a data entity that describes one or more text inputs for generating a predictive document. The input document 408 may include plurality of text segments that may correspond to one or more controlled fields 404 of a prediction domain. By way of example, the input document 408 may include an inference document with one or more request text fields from a generative text request.

In some embodiments, a generative text request is a message (e.g., an inter-service message, intra-service message, network message, etc.) that is descriptive of a request to generate a predictive document and/or one or more portions thereof. In some examples, a generative text request may be initiated from a user device using a generative service plug-in. For example, a generative text request may be defined by an application programming interface (API) that is accessible, via the generative service plug-in, from a user interface of the user device. The API may communicatively connect the user device to a computing system configured to process a request to generate a predictive document.

In some embodiments, a generative text request may include a request to generate a predictive document based on the input document 408. The input document 408, for example, may include one or more input texts and/or other metadata associated with a topic for a predictive document. For example, the one or more input texts may include one or more request text fields that correspond to one or more controlled fields 404 of a desired predictive document. In some examples, the other metadata may include a topic identifier, a type of generative model options, a requesting user, and/or the like.

In some embodiments, a user interface is an interface for a user device for managing one or more historical and/or predictive documents. In some examples, the user interface may include one or more document creation software tools configured to facilitate a creation, modification, and/or evaluation of a predictive document. By way of example, one of the one or more document creation software tools may include a generative service plug-in.

In some embodiments, the generative service plug-in is a software component that is configured to facilitate a generative text request. The generative service plug-in, for example, may include one or more portions of computer-readable media that, when executed by one or more processors, is configured to facilitate the generation of a generative text request from a user interface, provide the generative text request to a request tracking interface, and provide a response to the generative text request to the user interface.

In some embodiments, the request text fields are a component of a generative text request. A request text field may include a segment of text manually generated and/or automatically extracted for a particular case corresponding to a predictive document. Each request text field, for example, may include natural language text that reflects a portion of a decision for a particular case that corresponds to a controlled field 404 of a predictive document.

As one example, using healthcare appeal decision letter for illustration purposes, a desired predictive document may include “Appellant's Argument for Coverage,” “Justification for Decision,” and/or “Final Research” text fields that may be modified on a case-by-case basis. In such a case, the one or more request text fields may include (i) an “Appellant's Argument for Coverage” field including natural language text provided by an Appellant, (ii) a “Justification for Decision” field including natural language text provided by an appeal reviewer in response to the Appellant's arguments, and/or (iii) a “Final Research” field including natural language text to support the justification for a decision.

In some embodiments, an input text summary is generated for the input document 408. The input text summary, for example, may be generate using the large language summarization model 406. In some example, one or more input text summaries may be generated based on one or more controlled fields 404 for the prediction domain. For example, an individual input text summary may be generated for each of the one or more controlled fields 404.

In some embodiments, the input text summary is a data entity that describes a text segment of the input document 408. An input text summary may include a summarized portion of text that corresponds to a controlled field 404 of the input document 408. For example, an input text summary may be generated by extracting a text segment from the input document 408 that corresponds to a controlled field 404 and summarizing the text segment using the large language summarization model 406. In some examples, the input document 408 may be associated with a plurality of input text summaries. Each input text summary may correspond to a controlled field 404 within the input document 408. By way of example, for a healthcare, appeal process, an input document 408 may be associated with a respective input text summary for an appellant argument, a final rationale, a final justification, and/or the like.

In some embodiments, an input summary embedding is generated for the input text summary. For instance, one or more input summary embeddings 420 may be generated using a machine learning embedding model. In some examples, the one or more input summary embeddings 420 may include an input summary embedding for each input text summary from an input document 408.

In some embodiments, the input summary embedding is an encoded data entity (e.g., one or more vectors, etc.) that corresponds to an input text summary from the input document 408. An input summary embedding may include any type of text embedding including Word2Vec embeddings, TF-IDF embeddings, BERT embeddings, and/or the like. In some examples, an input summary embedding may include a Llama embedding (e.g., Llama 7b, etc.).

In some embodiments, a training cluster is identified for the input document 408 based on an embedding similarity between the input summary embeddings 420 and the plurality of training summary embeddings 418. In some embodiments, one or more prompt training text summaries 422 are identified for the input document 408 from the training cluster. For instance, one or more prompt training text summaries 422 may be identified for each controlled field 404 of the input document 408.

In some embodiments, the prompt training text summaries 422 are training text summaries from the training data store 412 that correspond to the input document 408. A prompt training text summary, for example, may include a training text summary from the training data store 412 that is associated with one of one or more highest embedding similarities with an input summary embedding from the input document 408. In some examples, one or more prompt training text summaries 422 may be identified for each input summary embedding associated with the input document 408.

In some embodiments, the prompt training text summaries 422 are identified from a training cluster identified for the input document 408. For example, a training cluster may be identified by generating a cluster similarity score for each of a plurality of training clusters 414 based on a comparison between (i) one or more input summary embeddings of the input document 408 and (ii) a plurality of training summary embeddings 418 of a subset of training documents 402 within a respective training cluster. For instance, an individual controlled field similarity score may be generated for each controlled field shared by the input document 408 and a training document based on an embedding similarity between an input summary embedding and a training summary embedding corresponding to the controlled field. A cluster similarity score may include an aggregation (e.g., average, etc.) of a plurality of controlled field similarity scores generated for a subset of training documents within a particular training cluster. In some examples, the controlled field similarity score may include a cosine similarity score and/or the aggregated cluster similarity score may include an average of a plurality of cosine similarity scores for a particular training cluster.

In this manner, once the embeddings are created, a training cluster may be identified from the training data store 412 for which the input summary embeddings belong to using cosine similarity. Once the training cluster is identified, one or more prompt training text summaries 422 may be extracted from the training cluster for each controlled field of the prediction domain. For example, one or more of the top rows (e.g., 3, 5, 15 etc.) of similarity data may be extracted for each controlled field 404.

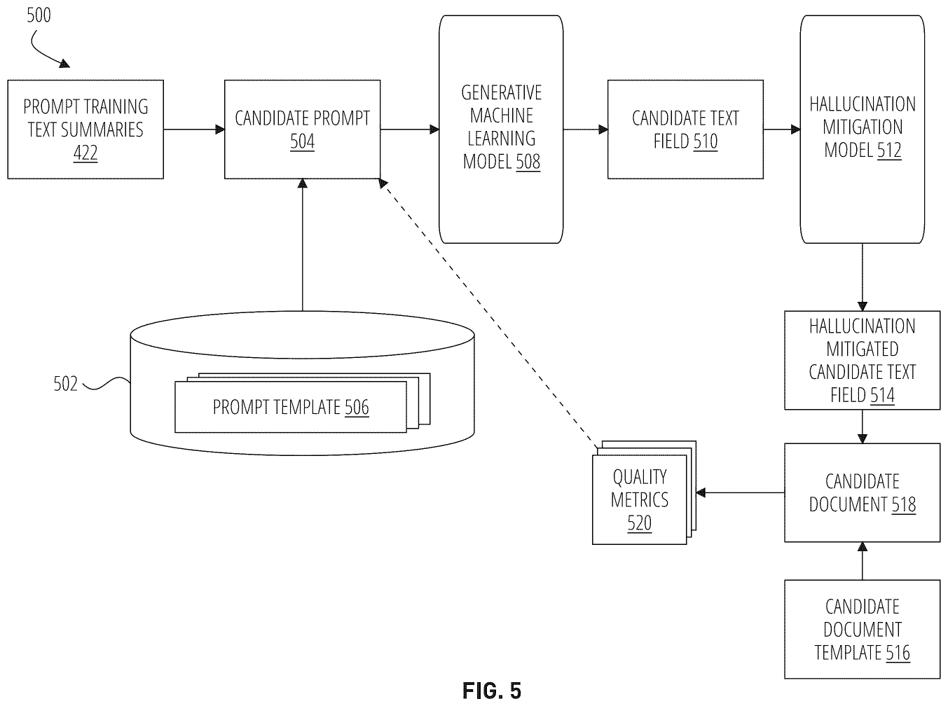

In some embodiments, the prompt training text summaries 422 are leveraged to engineer prompts for a generative machine learning model. By doing so, a generative text may be created that is grounded and based on historical examples that are contextually relevant to a particular use case. In some examples, the efficacy of a prompt may vary on a number of different factors that are difficult to predict due to the complexities of LLMs. To compensate for the variable nature of prompt engineering, the prompt training text summaries 422 may be incorporated to a plurality of candidate prompts, which may be evaluated to select an optimal prompt for a particular task. In this way, contextually relevant examples may be manipulated, using different prompting techniques, to improve the performance of traditional LLM with respect a diverse set of generative tasks. An example of a prompt selection technique is described in further detail with reference to FIG. 5.

FIG. 5 is a dataflow diagram 500 showing example data structures and modules for selecting a candidate prompt for a generative task in accordance with some embodiments discussed herein. The dataflow diagram 500, for example, illustrates a multi-stage prompt selection pipeline for intelligently identifying an optimal prompt for a generative machine learning model 508. The multi-stage prompt selection pipeline, for example, may include three iterative stages that may be repeated for a plurality of iterations to generate and evaluate a plurality of candidate prompts 504 for a generative task. In the first stage of an iteration, a candidate prompt 504 may be generated using one or more prompt templates 506 from a template data store 502. In the second stage of an iteration, the candidate prompt 504 may be leveraged to generate candidate text fields 510, which may be refined over one or more refinement operations and then incorporated to a candidate document 518 corresponding to the candidate prompt 504. In the third stage of the iteration, the candidate document 518 may be leveraged to generate quality metrics 520 for the candidate prompt 504. In this manner, at each iteration of the multi-stage prompt selection pipeline, comprehensive quality metrics 520 may be generated for one of a plurality of candidate prompts 504 for a generative task. By doing so, the multi-stage prompt selection pipeline may holistically evaluate each of a plurality of candidate prompts 504 to select an optimal prompt for a generative task. This, in turn, maximizes a performance of the generative machine learning model 508 based on a plurality of prompt training text summaries 422.

In some embodiments, a candidate prompt 504 is generated for a generative machine learning model 508 based on one or more training clusters and/or a prompt template 506. By way of example, the candidate prompt 504 may be generated based on the one or more prompt training text summaries 422 that are identified from one or more training clusters. In some examples, the candidate prompt 504 may be generated by modifying the prompt template 506 to add the one or more prompt training text summaries 422. The prompt template 506, for example, may include a few-shot prompt and the one or more prompt training text summaries 422 may be added as examples for the few-shot prompt. In some examples, the prompt template 506 is one of a plurality of prompt templates from a template data store 502. As described above, a plurality of candidate prompts may be generated over one or more iterations of the multi-stage prompt selection pipeline. In some example, each of the plurality of candidate prompts may correspond to a different prompt template from the plurality of prompt templates of the template data store 502.

In some embodiments, the prompt template 506 is a data entity that describes a predefined structure for a generative model prompt. A prompt template 506, for example, may include a no-shot prompt template, a few-shot prompt template, and/or the like. The prompt template 506 may include one or more model-specific fields that may be tailored to a particular LLM. In addition, or alternatively, the prompt template 506 may include one or more instruction sets for guiding an LLM for a particular generative task. In some examples, the instruction sets may be dynamically tailored and/or selected for a specific generative task. For instance, the prompt template 506 may be selected from a plurality of prompt templates within a template data store 502 based on an efficacy of the template's instruction set for the specific generative task.

In some embodiments, the template data store 502 is a data structure that describes a plurality of candidate prompt templates for a prediction domain. The template data store 502 may include any type (and any number) of data storage structures including, as examples, one or more linked lists, databases (e.g., relational databases, graph database, etc.), and/or the like.

In some embodiments, the template data store 502 may include a plurality of candidate prompt templates, each with a different instruction set for facilitating a generative model output. In some examples, an optimized prompt template may be selected from the template data store 502 for a particular generative task using a voting technique defined by one or more quality assessment techniques of the present disclosure.

In some embodiments, the candidate prompt 504 is a data entity that describes a prompt template 506 that is populated by one or more prompt training text summaries 422. For example, one or more prompt training text summaries 422 identified for the input document 408, using some of the techniques of the present disclosure, may be combined with a candidate prompt template to generate the candidate prompt 504. The one or more prompt training text summaries 422, for example, may be appended as one or more training examples for a generative machine learning model 508. By way of example, once the prompt training text summaries 422 are identified, they may be combined with a suitable prompt retrieved from a template data store 502 to build a prompt for generating a text for a predictive document via the generative machine learning model 508.

In some embodiments, the candidate prompt 504 is provided to the generative machine learning model 508 to receive at least a portion of a candidate document 518. For example, the generative machine learning model 508 may generate a candidate text field 510 in response to the candidate prompt 504. For example, the at least a portion of the candidate document 518 may include a candidate text field 510 for a candidate document template 516 corresponding to the candidate document 518.

In some embodiments, the generative machine learning model 508 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The generative machine learning model 508 may include any type of model configured, trained, and/or the like to generate natural language text in response to a textual prompt, such as the candidate prompt 504, as described herein. For example, the generative machine learning model 508 may include a GPT model.

In some examples, the candidate prompt 504 may be provided to the generative machine learning model 508 to generate one or more candidate text fields 510 for a candidate document 518.

In some embodiments, a candidate text field 510 is a component of a candidate document 518. The candidate text field 510, for example, may include a text segment for a controlled field of the candidate document 518. For instance, the candidate text field 510 may include natural language text output from the generative machine learning model 508 in response to the candidate prompt 504. For instance, the candidate prompt 504 may be passed to a few-shot trainer module, where the generative machine learning model 508 may generate text in accordance with the candidate prompt 504. In some examples, a separate candidate prompt may be generated for each controlled field in a candidate document 518 and the candidate text fields may be individually generated by the generative machine learning model 508, in accordance with the separate candidate prompts, for each of the controlled fields.

In some embodiments, a hallucination mitigated candidate text field 514 is generated from the candidate text field 510. For instance, the hallucination mitigated candidate text field 514 may be generated, using a hallucination mitigation model 512, based on a hallucination mitigation prompt.

In some embodiments, the hallucination mitigated candidate text field 514 is a processed candidate text field 510 that is processed to filter hallucinated text from the candidate text field 510. For example, candidate text fields 510 may be passed to the hallucination mitigation model 512 to remove suspected hallucinations from the candidate text fields 510. In this manner, anomalous generative text output by a generative machine learning model 508 may be identified and removed to clean the generative text segments.

In some embodiments, the hallucination mitigation model 512 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The hallucination mitigation model 512 may include any type of model configured, trained, and/or the like to filter natural language text in response to a textual prompt, such as a hallucination mitigation prompt, as described herein. For example, the hallucination mitigation model 512 may include a GPT model trained to detect and filter hallucinations from natural language text generated by the generative machine learning model 508. For example, for hallucination removal, synthetic document examples may be leveraged which will serve as contrastive learning samples within the hallucination mitigation prompt.

In some embodiments, the hallucination mitigation prompt is a generative model prompt for instructing the hallucination mitigation model 512 to filter hallucinations from a generative text segment, such as the candidate text field 510. In some examples, the hallucination mitigation prompt may include one or more synthetic examples of hallucinated context and/or a contextual prompt for instructing the identification and removal of hallucination context from an input generative text segment based on the one or more synthetic examples. By way of example, the hallucination mitigation prompt for a healthcare prediction domain may include:

{″role″: ″system″, ″content″:″ You are an assistant that validates Health
Insurance Appeal decisions that are sent to clients by looking at the
provided examples. ″
″Try to see if all the information in the Concern field is relevant to the
information provided in the field Appeal Argument, Denial Rationale and
Claim”.
″If any irrelevant information is there remove the irrelevant information &
re-phrase the Concern″
}
{″role”:” user″,
“Content”:
Provider: provider1
Claim: claim1
Denial Rationale: denial_rationale1
Appeal Argument: appeal_argument1
Concerns:
}
{″role”:” assistant″,
Concern removing irrelevant information/hallucinations.
}

In some embodiments, a candidate document template 516 is identified for the candidate document 518. The candidate document 518 may be generated by adding the hallucination mitigated candidate text field 514 to the candidate document template 516.

In some embodiments, a candidate document template 516 is a data entity that describes a predefined structure for a candidate document 518. The candidate document template 516, for example, may include one or more static and/or dynamic text segments that are structured according to a specific document format. The static text segments may include contextual information that universally applies to a type of candidate document 518. The dynamic text segments may be specific to a particular candidate document 518. The dynamic text segments, for example, may include rule-based information that may be populated using one or more rule-based techniques (e.g., a date formatter, etc.). In addition, or alternatively, the dynamic text segments may include one or more controlled fields that apply to a particular type of candidate document 518. In some examples, the one or more controlled fields may be populated with candidate text fields 510 generated using one or more techniques of the present disclosure.

In some embodiments, the candidate document is a document that describes a particular case corresponding to an input document. The candidate document 518, for example, may include a candidate document template 516 that is populated with a plurality of candidate text fields 510. For example, after the candidate text fields 510 are generated, the candidate text fields 510 may be passed to a letter formatter, which may identify a candidate document template 516, from a document template data store, that corresponds to the set of generated candidate text fields 510. Once identified, the candidate document template 516 may be populated with the candidate text fields 510 to generate the candidate document 518.

In some embodiments, a plurality of quality metrics 520 are generated for the candidate prompt 504 based on the candidate document 518. In some embodiments, a quality metric is a quality measure that describes a particular aspect of the candidate prompt 504. For example, once a candidate document 518 is generated using the candidate prompt 504, the candidate document 518 may be leveraged to generate a plurality of quality metrics 520 that may be correlative to an efficacy of the candidate prompt 504. The quality metrics 520, for example, may each be tailored to a goal aspect of a predictive document. In this manner, different quality measures for the candidate document 518 may by leveraged to assess the efficacy of the candidate prompt 504 across a plurality of different assessment channels. In some examples, a quality metric may include a sub-component of a weighted quality score that aggregates quality scores across the plurality of different assessment channels. By way of example, a quality metric may include one or more multi-prompt-based assessment metrics, one or more string-based assessment metrics, one or more embedding-based assessment metrics, and/or the like that may be aggregated to generate a holistic quality score for a candidate document 518 that may be attributed back to a corresponding candidate prompt 504.

In some embodiments, the candidate prompt 504 is selected from a plurality of candidate prompts based on the plurality of quality metrics 520. In some examples, the selected candidate prompt 504 may be provided to the generative machine learning model 508 to receive at least a portion of a predictive document.

In some embodiments, the predictive document is a document with a plurality of a generative text fields. The plurality of generative text fields, for example, may each be generated using the generative machine learning model 508 and the candidate prompt 504 selected using one or more techniques of the present disclosure. For example, using one or more techniques of the present disclosure, a few-shot prompt may be designed for each dynamic text field of a candidate document template 516 and the candidate document template 516 may be populated, with generative text fields output using the few-shot prompts, to generate the predictive document. In some embodiments, the predictive document may be provided to a human for manual review and once accepted, may be added as a training document for future prompt designs. In this manner, the techniques of the present disclosure may continuously adapt to new circumstances as they arise within a prediction domain.

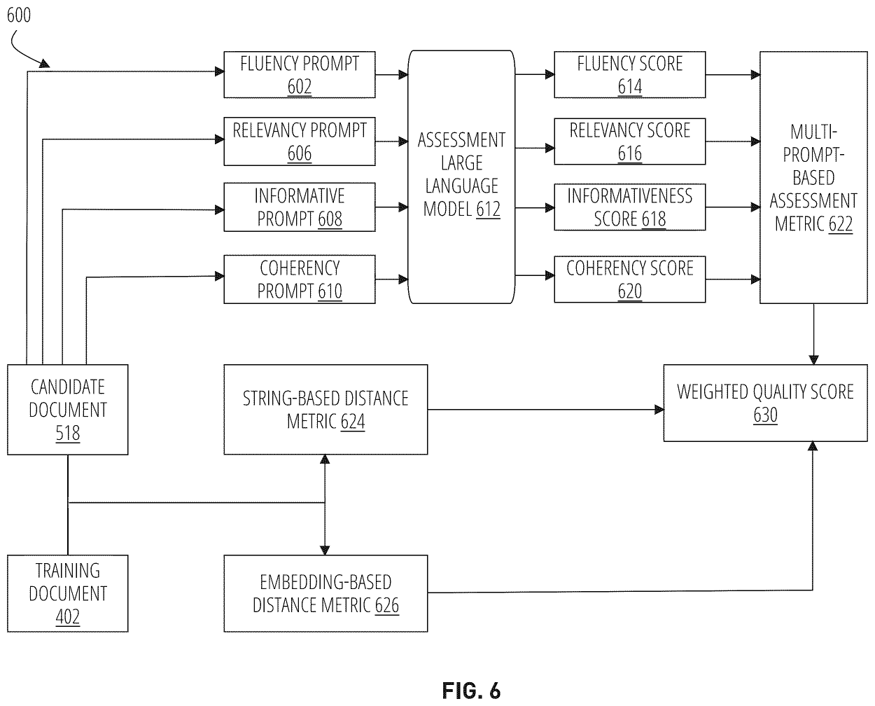

As described herein, the candidate prompt 504 may be selected based on a plurality of quality metrics 520. In some examples, the quality metrics 520 may include a plurality of multi-channel metrics that may be generated to holistically evaluate a candidate prompt 504 based on candidate document generated using the candidate prompt 504. In some examples, the multi-channel metrics may be combined to generate a single, comprehensive metric indicative of a performance enabled by a particular prompt. The single, comprehensive metric may be generated through multi-channel assessment techniques, which is described in further detail with reference to FIG. 6.

FIG. 6 is a dataflow diagram 600 showing example data structures and modules for generating multi-channel assessment metrics for a candidate prompt in accordance with some embodiments discussed herein. The dataflow diagram 600, for example, illustrates multi-channel assessment techniques for holistically evaluating a candidate prompt based on an output (e.g., candidate document 518) facilitated by the candidate prompt. As shown, the multi-channel assessment techniques may generate a plurality of different, multi-channel assessment metrics including one or more of the multi-prompt-based assessment metric 622, string-based distance metric 624, and/or embedding-based distance metric 626. Each of these quality metrics may be aggregated to generate a single, weighted quality score 630 that holistically evaluated a combination of different aspects associated with a candidate prompt. In this manner, the multi-channel assessment techniques enable the selection of an optimal prompt with respect to a plurality of different, but interrelated aspects of a generated task. This, in turn, allows for greater transparency and explainability of model outputs in addition to other technical advantages of the present disclosure.

In some embodiments, a plurality of quality metrics includes a multi-prompt-based assessment metric 622, a string-based distance metric 624, and an embedding-based distance metric 626. In some embodiments, the multi-prompt-based assessment metric is generated based on one or more combinations of a fluency score 614, a relevancy score 616, an informativeness score 618, and/or a coherency score 620.

For instance, the fluency score 614 may be generated for the candidate document 518, using an assessment large language model 612, based on a fluency prompt 602, the candidate document 518, and, in some examples, a training document 402 from a training cluster corresponding to the candidate prompt.

In some embodiments, the fluency score 614 is generated, using an assessment LLM 612, based on the fluency prompt 602. By way of example, the fluency score 614 may be generated using a prompt-based document assessment by providing a document and the fluency prompt 602 to the assessment LLM 612. An example, fluency prompt 602 may be defined as follows:
Score the following [task-ins] with respect to [aspect] on a continuous scale from 0 to 100, where a score of zero means “[ant-aspect]” and score of one hundred means “perfect [aspect]”. Note that [aspect] measures [Fluency].
[Generated Text]
Human reference: [A Reference]
Scores:
   In some examples, the fluency prompt 602 may include a plurality of annotated examples (e.g., human references, etc.) for instructing the assessment LLM 612 to assess a fluency of a document.

In some embodiments, the assessment LLM 612 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The assessment LLM 612 may include any type of model configured, trained, and/or the like to generate natural language text in response to a textual prompt, such as an assessment prompt, as described herein. For example, the assessment LLM 612 may include a GPT model.

In some examples, an assessment prompt, such as the fluency prompt 602, may be provided to the assessment LLM 612 to generate one or more quality metrics 520 for the candidate document 518.

In addition, or alternatively, relevancy score 616 may be generated for the candidate document 518, using the assessment LLM 612, based on a relevancy prompt 606, the candidate document 518, and the training document 402.

In some embodiments, the relevancy score 616 is generated, using the assessment LLM 612, based on the relevancy prompt 606. By way of example, the relevancy score 616 may be generated using a prompt-based document assessment by providing a document and the relevancy prompt 606 to the assessment LLM 612. An example, relevancy prompt 606 may be defined as follows:
Score the following [task-ins] with respect to [aspect] on a continuous scale from 0 to 100, where a score of zero means “[ant-aspect]” and score of one hundred means “perfect [aspect]”. Note that [aspect] measures [Relevance].
[Generated Text]
Human reference: [A Reference]
   In some examples, the relevancy prompt 604 may include a plurality of annotated examples (e.g., human references, etc.) for instructing the assessment LLM 612 to assess a relevancy of a document.

In addition, or alternatively, an informativeness score 618 may be generated for the candidate document 518, using the assessment LLM 612, based on an informative prompt 608, the candidate document 518, and the training document 402.

In some embodiments, the informativeness score 618 is generated, using the assessment LLM 612, based on the informative prompt 608. By way of example, the informativeness score 618 may be generated using a prompt-based document assessment by providing a document and the informative prompt 608 to the assessment LLM 612. An example, informative prompt 608 may be defined as follows:
Score the following [task-ins] with respect to [aspect] on a continuous scale from 0 to 100, where a score of zero means “[ant-aspect]” and score of one hundred means “perfect [aspect]”. Note that [aspect] measures [Informativeness].
[Generated Text]
Human reference: [A Reference]
Scores:
   In some examples, the informative prompt 608 may include a plurality of annotated examples (e.g., human references, etc.) for instructing the assessment LLM 612 to assess an informativeness of a document. In addition, or alternatively, the informative prompt 608 may include a ground truth document (e.g., training document 402) for assessing an informativeness of a document relative to the ground truth document.

In addition, or alternatively, a coherency score 620 may be generated for the candidate document, using the assessment LLM 612, based on a coherency prompt 610, the candidate document 518, and the training document 402.

In some embodiments, a coherency score 620 is generated, using the assessment LLM 612, based on the coherency prompt 610. By way of example, the coherency score 620 may be generated using a prompt-based document assessment by providing a document and the coherency prompt 610 to the assessment LLM 612. An example, coherency prompt 610 may be defined as follows:
Score the following [task-ins] with respect to [aspect] on a continuous scale from 0 to 100, where a score of zero means “[ant-aspect]” and score of one hundred means “perfect [aspect]”. Note that [aspect] measures [Coherence].
[Generated Text]
Human reference: [A Reference]
Scores:
   In some examples, the coherency prompt 610 may include a plurality of annotated examples (e.g., human references, etc.) for instructing the assessment LLM 612 to assess a coherency of a document.

In some embodiments, the multi-prompt-based assessment metric 622 is based on a weighted aggregation of the fluency score 614, the relevancy score 616, the informativeness score 618, and/or the coherency score 620.

In some embodiments, the multi-prompt-based assessment metric 622 is a type of quality metric that is reflective of a natural language quality of a document. The multi-prompt-based assessment metric 622, for example, may be reflective of one or more human-based metrics for a document. By way of example, the multi-prompt-based assessment metric 622 may include an aggregation of a plurality of generative scores that respectively judge a quality of a document based on subjective measures, such as a fluency, coherency, informativeness, relevance, and/or the like of a document. Each of the generative scores may be generated using an assessment prompt that includes a contextual prompt and/or one or more examples for assessing a particular subjective quality of a document.

In some embodiments, the multi-prompt-based assessment metric 622 includes a weighted aggregate of a plurality of generative scores, including the fluency score 614, the relevancy score 616, the informativeness score 618, and/or the coherency score 620. In some examples, the weights may be learned over time based on one or more annotated labels for predictive documents. The labels, for example, may include a ground truth multi-prompt-based assessment metric for a training predictive document and one or more corresponding generative scores. In some examples, the weights may be at least initially set. As one example, the multi-prompt-based assessment metric may be defined as:

$$Avg\_metric = ( Coherency score * 0.2 + Relevancy score * 0.2 + Fluency score * 0.1 + Informativeness score * 0. 5 )$$

In some embodiments, a string-based distance metric 624 is generated based on a string comparison between the candidate document 518 and the training document 402 from the training clusters corresponding to the candidate prompt.

In some embodiments, the string-based distance metric 624 is a type of quality metric that is reflective of a syntactic quality of a document. The string-based distance metric 624, for example, may be reflective of a document syntactic similarity to a ground truth document (e.g., a training document 402, etc.). For example, the string-based distance metric 624 may include a Levenshtein distance. The Levenshtein distance, for example, may include a measure of a difference between two strings of characters, defined as the minimum number of single-character edits (insertions, deletions, or substitutions) required to transform one string into the other. In the context of generative text quality, the Levenshtein distance may be used to evaluate how syntactically similar a document is to a training document 402.

In some examples, the string-based distance metric 624 may include the Levenshtein distance combined with a sematic measure, such as a cosine distance between a document and a training document 402. For example, the string-based distance metric 624 may include a weighted distance, which takes an equal proportion of the Levenshtein and cosine distances and passes it to a neural network approximator function, which may convert the distance into the string-based distance metric 624.

In some embodiments, the embedding-based distance metric 626 is generated based on an embedding comparison between the candidate document 518 and the training document 402 from the training cluster corresponding to the candidate prompt.

In some embodiments, the embedding-based distance metric 626 is a type of quality metric that is reflective of a semantic quality of a document. The embedding-based distance metric 626, for example, may be reflective of a document semantic similarity to a ground truth document (e.g., a training document 402, etc.). For example, the embedding-based distance metric 626 may include a modified cosine distance. The cosine distance may include a measure of the similarity between two vectors in a high-dimensional space. In the context of generative text quality, the cosine distance may be used to evaluate how semantically similar a document is to a training document 402 based on semantic and/or contextual information rather than syntactic differences between texts. In some examples, the embedding-based distance metric 626 may include a cosine distance between llama-based embeddings of the document and the training document 402. In some examples, the cosine distance may be discretized into one or more buckets (e.g., on a scale 1-5) to generate the embedding-based distance metric 626.

In some embodiments, a candidate prompt is selected from the plurality of candidate prompts based on a weighted quality score 630 for the candidate prompt that is derived from the multi-prompt-based assessment metric 622, the string-based distance metric 624, and/or the embedding-based distance metric 626. For instance, the weighted quality score 630 for the candidate prompt may be based on the multi-prompt-based assessment metric 622, the string-based distance metric 624, and the embedding-based distance metric 626. A candidate prompt may be selected based on a comparison between the weighted quality score 630 and a plurality of weighted quality scores corresponding to the plurality of candidate prompts.

In some embodiments, the weighted quality score 630 is an aggregated quality score for the candidate prompt 504. For example, the weighted quality score 630 may include an aggregation of the multi-prompt-based assessment metric 622, the string-based distance metric 624, and/or the embedding-based distance metric 626. In some examples, the weighted quality score 630 may include an average of the quality metrics. In addition, or alternatively, the weighted quality score 630 may include a weighted average of the quality metrics. In some examples, the weighted average may be learned over time using one or more annotated training documents. In some examples, the candidate prompt 504 associated with a best weighted average score may be selected to generate a predictive document for an input document.

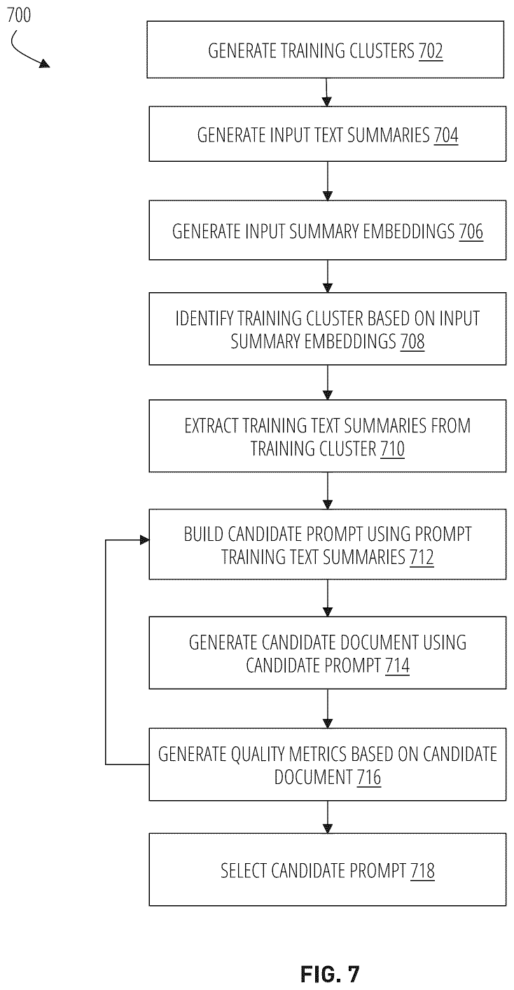

FIG. 7 is a flowchart diagram of an example process 700 for selecting a candidate prompt for a generative task in accordance with some embodiments discussed herein. The flowchart depicts a multi-stage prompt engineering and selection process 700 for improving the performance of LLMs with respect to diverse use cases. The process 700 may be implemented by one or more computing devices, entities, and/or systems described herein. For example, via the various steps/operations of the process 700, the computing system 101 may leverage improved prompt engineering and selection techniques to engineer, score, and then select an optimal generative prompt for an LLM. By doing so, the process 700 facilitates text generation techniques that are directly tailored to addressing technical challenges of traditional prompt engineering techniques that are not adaptable to diverse use cases. This, in turn, lead to improved LLM performance through the generation of optimized LLM instruction sets.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes, at step/operation 702, generating a plurality of training clusters. For example, the computing system 101 may generate a plurality of training clusters by segmenting a plurality of training documents into one or more spectral clusters. For example, the computing system 101 may generate, using a large language summarization model, a plurality of training text summaries for the plurality of training documents based on one or more controlled fields for the prediction domain. The computing system 101 may generate, using a machine learning embedding model, a plurality of training summary embeddings for the plurality of training text summaries. The computing system 101 may identify, using a machine learning clustering model, the subset of the plurality of training documents based on the plurality of training summary embeddings.

In some embodiments, the process 700 includes, at step/operation 704, generating a plurality of input text summaries. For example, the computing system 101 may generate, using the large language summarization model, an input text summary for the input document based on the one or more controlled fields for the prediction domain.

In some embodiments, the process 700 includes, at step/operation 706, generating a plurality of input summary embeddings. For example, the computing system 101 may generate, using the machine learning embedding model, an input summary embedding for the input text summary.

In some embodiments, the process 700 includes, at step/operation 708, identifying a training cluster based on the input summary embeddings. For example, the computing system 101 may identify a training cluster for an input document. In some examples, the training cluster includes a subset of a plurality of training documents for the prediction domain. In some examples, the computing system 101 may identify the training cluster based on an embedding similarity between the input summary embedding and the plurality of training summary embeddings.

In some embodiments, the process 700 includes, at step/operation 710, extracting training text summaries from the training cluster. For example, the computing system 101 may identify one or more prompt training text summaries from the training cluster.

In some embodiments, the process 700 includes, at step/operation 712, building a candidate prompt using prompt training text summaries. For example, the computing system 101 may generate a candidate prompt for a generative machine learning model based on the training cluster and a prompt template. In some examples, the computing system 101 may modify the prompt template to add the one or more prompt training text summaries. For instance, the prompt template may include a few-shot prompt and the one or more prompt training text summaries may be added as examples for the few-shot prompt.

In some embodiments, the prompt template is one of a plurality of prompt templates from a template data store and each of a plurality of candidate prompts (e.g., iteratively generated across one or more iterations of steps/operations 712-716) may correspond to a different prompt template from the plurality of prompt templates.

In some embodiments, the process 700 includes, at step/operation 714, generating a candidate document using the candidate prompt. For example, the computing system 101 may provide the candidate prompt to the generative machine learning model to receive at least a portion of a candidate document.

In some embodiments, the process 700 includes, at step/operation 716, generating a plurality of quality metrics based on the candidate document. For example, the computing system 101 may generate the plurality of quality metrics for the candidate prompt based on the candidate document. In some examples, the plurality of quality metrics may include a multi-prompt-based assessment metric, a string-based distance metric, and/or an embedding-based distance metric.

In some embodiments, the process 700 includes, at step/operation 718, selecting the candidate prompt. For example, the computing system 101 may select the candidate prompt from a plurality of candidate prompts based on the plurality of quality metrics. In some examples, the computing system 101 may generate a weighted quality score for the candidate prompt based on the multi-prompt-based assessment metric, the string-based distance metric, and/or the embedding-based distance metric and select the candidate prompt based on a comparison between the weighted quality score and a plurality of weighted quality scores corresponding to the plurality of candidate prompts (e.g., iteratively generated across one or more iterations of steps/operations 712-716).

In some embodiments, once selected, the computing system 101 provides the candidate prompt to the generative machine learning model to receive at least a portion of a predictive document.

Some techniques of the present disclosure enable the generation of action outputs that may be performed to initiate one or more real world actions to achieve real-world effects. The prompt engineering and quality assessment techniques of the present disclosure may be used, applied, and/or otherwise leveraged to generate reliable text, which may help in the creation and provisioning of messages across computing entities, as well as other downstream tasks. For instance, a predictive document, using some of the techniques of the present disclosure, may trigger the performance of actions at a client device, such as the display, transmission, and/or the like of data reflective of generative text. In some embodiments, the generative text may trigger an alert of an appeal decision in a healthcare scenario. The alert may be automatically communicated to a user associated with the appeal decision. In addition, or alternatively, the generative text may trigger an allocation of currency, mailing of a physical letter, and/or the like. Moreover, quality assessment techniques, and/or the quality metrics output using the quality assessment techniques, thereof, may trigger similar tasks. In some examples, the quality metrics, such as the weighted quality score, may trigger one or more automated training operations for one or more machine learning models of the present disclosure.

In some examples, the computing tasks may include actions that may be based on a text generation domain. A text generation domain may include any environment in which computing systems may be applied to generate text and initiate the performance of computing tasks responsive to the generative text. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

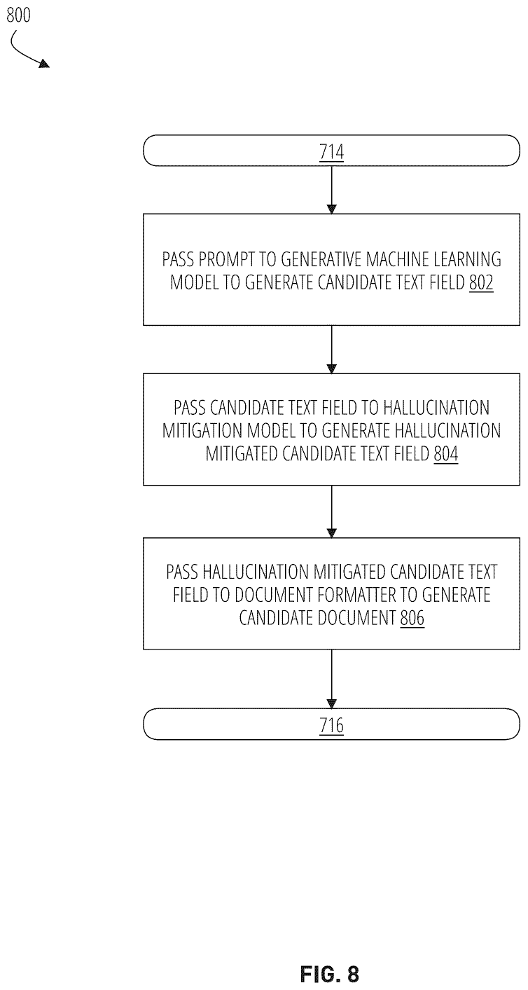

FIG. 8 is a flowchart diagram of an example process for generating a generative text document in accordance with some embodiments discussed herein. The flowchart depicts a multi-stage generative process 800 for improving the performance of LLMs by processing the outputs of LLMs across one or more stages of a machine learning process pipeline. At each stage, an output of an LLM may be processed to directly address technical challenges with traditional LLMs, such as the tendency to hallucinate anomalous text. The process 800 may be implemented by one or more computing devices, entities, and/or systems described herein. For example, via the various steps/operations of the process 800, the computing system 101 may leverage an improved text generation techniques to incrementally refine a generative text output by an LLM. By doing so, the process 800 facilitates text generation techniques that are directly tailored to addressing technical challenges of traditional generative modeling techniques.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 may begin after and/or include one or more suboperations of step/operation 714 of FIG. 7, where the process 700 includes generating a candidate document using a candidate prompt.

In some embodiments, the process 800 includes, at step/operation 802, passing a prompt to a generative machine learning model to generate a candidate text field. For example, the computing system 101 may generate, using the generative machine learning model, the candidate text field based on a candidate prompt. In some examples, at least a portion of a candidate document may include a candidate text field for a candidate document template corresponding to the candidate document.

In some embodiments, the process 800 includes, at step/operation 804, passing a candidate text field to a hallucination mitigation model to generate a hallucination mitigated candidate text field. For example, the computing system 101 may generate, using a hallucination mitigation model, a hallucination mitigated candidate text field from the candidate text field based on a hallucination mitigation prompt.

In some embodiments, the process 800 includes, at step/operation 802, pass the hallucination mitigated candidate text field to a document formatter to generate a candidate document. For example, the computing system 101 may identify the candidate document template for the candidate document and generate the candidate document by adding the hallucination mitigated candidate text field to the candidate document template.

In some embodiments, the process 800 may then proceed to step/operation 716 of FIG. 7, where the process 700 includes generating quality metrics for a candidate prompt based on the candidate document.

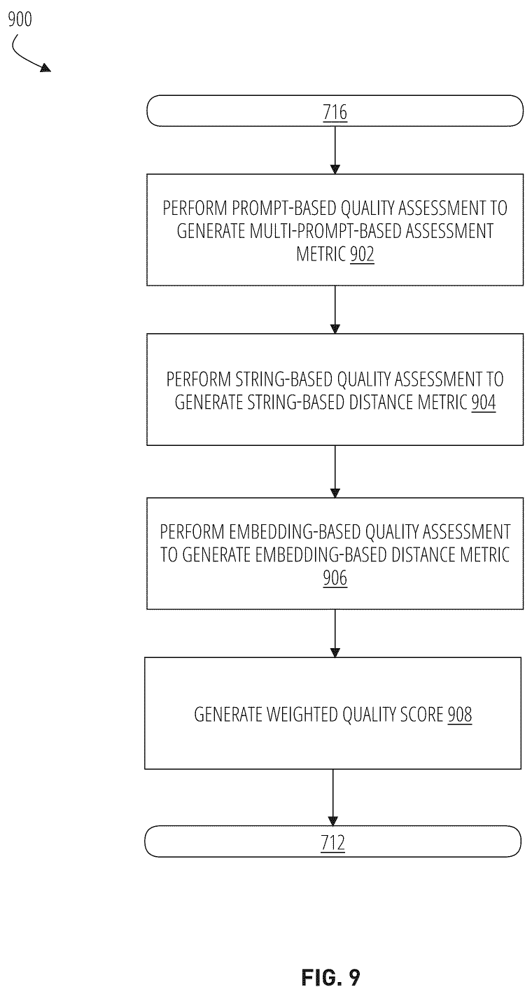

FIG. 9 is a flowchart diagram of an example process 900 for generating a weighted quality score for a candidate prompt in accordance with some embodiments discussed herein. The flowchart depicts a multi-stage quality assessment process 900 for improving the performance of LLMs through holistic quality evaluations. The process 900 may be implemented by one or more computing devices, entities, and/or systems described herein. For example, via the various steps/operations of the process 900, the computing system 101 may leverage improved quality assessment techniques to evaluate a holistic performance of a generative model prompt. By doing so, the process 900 facilitates text generation techniques that are directly tailored to addressing technical challenges of traditional prompt engineering techniques that fail to accurately evaluate various interrelated aspects of a generative prompt and/or the LLMs that rely on the generative prompt to generate predictive outputs.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 may begin after and/or include one or more suboperations of step/operation 716 of FIG. 7, where the process 700 includes generating quality metrics based on a candidate document.

In some embodiments, the process 900 includes, at step/operation 902, performing prompt-based quality assessment to generate a multi-prompt-based assessment metric for a candidate document. For example, the computing system 101 may generate, using an assessment LLM, a fluency score for the candidate document based on a fluency prompt, the candidate document, and a training document from the training cluster. The computing system 101 may generate, using the assessment LLM, a relevancy score for the candidate document based on a relevancy prompt, the candidate document, and the training document. The computing system 101 may generate, using the assessment LLM, an informativeness score for the candidate document based on an informative prompt, the candidate document, and the training document. The computing system 101 may generate, using the assessment LLM, a coherency score for the candidate document based on a coherency prompt, the candidate document, and the training document. And, the computing system 101 may generate the multi-prompt-based assessment metric based on a weighted aggregation of the fluency score, the relevancy score, the informativeness score, and the coherency score.

In some embodiments, the process 900 includes, at step/operation 904, performing string-based quality assessment to generate a string-based distance metric. For example, the computing system 101 may generate the string-based distance metric based on a string comparison between the candidate document and a training document from the training cluster.

In some embodiments, the process 900 includes, at step/operation 906, performing embedding-based quality assessment to generate an embedding-based distance metric. For example, the computing system 101 may generate the embedding-based distance metric based on an embedding comparison between the candidate document and a training document from the training cluster.

In some embodiments, the process 900 includes, at step/operation 908, generating a weighted quality score. For example, the computing system 101 may generate the weighted quality score based on a weighted aggregation of the multi-prompt-based assessment metric, the string-based distance metric, and/or the embedding-based distance metric.

In some embodiments, the process 900 may then return to step/operation 712 of FIG. 7, where the process 700 includes generating another candidate prompt using one or more training text summaries. In this manner, a plurality of quality metrics may be generated, over multiple iterations of steps/operations 712-716, for each of a plurality of candidate prompts. This, in turn, enables an intelligent selection of a candidate prompt based on the performance of an LLM in response to the candidate prompt.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising identifying, by one or more processors, a training cluster for an input document; generating, by the one or more processors, a candidate prompt for a generative machine learning model based on the training cluster and a prompt template; providing, by the one or more processors, the candidate prompt to the generative machine learning model to receive at least a portion of a candidate document; generating, by the one or more processors, a plurality of quality metrics for the candidate prompt based on the candidate document; and selecting, by the one or more processors, the candidate prompt from a plurality of candidate prompts based on the plurality of quality metrics.

Example 2. The computer-implemented method of example 1, wherein the training cluster comprises a subset of a plurality of training documents for a prediction domain and the training cluster is previously generated by generating, using a large language summarization model, a plurality of training text summaries for the plurality of training documents based on one or more controlled fields for the prediction domain; generating, using a machine learning embedding model, a plurality of training summary embeddings for the plurality of training text summaries; and identifying, using a machine learning clustering model, the subset of the plurality of training documents based on the plurality of training summary embeddings.

Example 3. The computer-implemented method of example 2, wherein identifying the training cluster comprises generating, using the large language summarization model, an input text summary for the input document based on the one or more controlled fields for the prediction domain; generating, using the machine learning embedding model, an input summary embedding for the input text summary; and identifying the training cluster based on an embedding similarity between the input summary embedding and the plurality of training summary embeddings.

Example 4. The computer-implemented method of any of the preceding examples, wherein generating the candidate prompt for the generative machine learning model comprises identifying one or more prompt training text summaries from the training cluster; and modifying the prompt template to add the one or more prompt training text summaries.

Example 5. The computer-implemented method of example 4, wherein the prompt template comprises a few-shot prompt and the one or more prompt training text summaries are added as examples for the few-shot prompt.

Example 6. The computer-implemented method of any of the preceding examples, wherein the prompt template is one of a plurality of prompt templates from a template data store and each of the plurality of candidate prompts correspond to a different prompt template from the plurality of prompt templates.

Example 7. The computer-implemented method of any of the preceding examples, wherein the plurality of quality metrics comprises a multi-prompt-based assessment metric, a string-based distance metric, and an embedding-based distance metric, and wherein selecting the candidate prompt from the plurality of candidate prompts comprises generating a weighted quality score for the candidate prompt based on the multi-prompt-based assessment metric, the string-based distance metric, and the embedding-based distance metric; and selecting the candidate prompt based on a comparison between the weighted quality score and a plurality of weighted quality scores corresponding to the plurality of candidate prompts.

Example 8. The computer-implemented method of example 7, wherein the multi-prompt-based assessment metric is generated by generating, using an assessment large language model (LLM), a fluency score for the candidate document based on a fluency prompt, the candidate document, and a training document from the training cluster; generating, using the assessment LLM, a relevancy score for the candidate document based on a relevancy prompt, the candidate document, and the training document; generating, using the assessment LLM, an informativeness score for the candidate document based on an informative prompt, the candidate document, and the training document; generating, using the assessment LLM, a coherency score for the candidate document based on a coherency prompt, the candidate document, and the training document; and generating the multi-prompt-based assessment metric based on a weighted aggregation of the fluency score, the relevancy score, the informativeness score, and the coherency score.

Example 9. The computer-implemented method of examples 7 or 8, wherein the string-based distance metric is generated based on a string comparison between the candidate document and a training document from the training cluster.

Example 10. The computer-implemented method of any of examples 7 through 9, wherein the embedding-based distance metric is generated based on an embedding comparison between the candidate document and a training document from the training cluster.

Example 11. The computer-implemented method of any of the preceding examples, wherein the at least a portion of the candidate document comprises a candidate text field for a candidate document template corresponding to the candidate document and the computer-implemented method further comprises generating, using a hallucination mitigation model, a hallucination mitigated candidate text field from the candidate text field based on a hallucination mitigation prompt; identifying the candidate document template for the candidate document; and generating the candidate document by adding the hallucination mitigated candidate text field to the candidate document template.

Example 12. The computer-implemented method of any of the preceding examples, further comprising providing the candidate prompt to the generative machine learning model to receive at least a portion of a predictive document.

Example 13. A computing system comprising memory and one or more processors communicatively coupled to the memory, the one or more processors configured to identify a training cluster for an input document; generate a candidate prompt for a generative machine learning model based on the training cluster and a prompt template; provide the candidate prompt to the generative machine learning model to receive at least a portion of a candidate document; generate a plurality of quality metrics for the candidate prompt based on the candidate document; and select the candidate prompt from a plurality of candidate prompts based on the plurality of quality metrics.

Example 14. The computing system of example 13, wherein the training cluster comprises a subset of a plurality of training documents for a prediction domain and the training cluster is previously generated by generating, using a large language summarization model, a plurality of training text summaries for the plurality of training documents based on one or more controlled fields for the prediction domain; generating, using a machine learning embedding model, a plurality of training summary embeddings for the plurality of training text summaries; and identifying, using a machine learning clustering model, the subset of the plurality of training documents based on the plurality of training summary embeddings.

Example 15. The computing system of example 14, wherein identifying the training cluster comprises generating, using the large language summarization model, an input text summary for the input document based on the one or more controlled fields for the prediction domain; generating, using the machine learning embedding model, an input summary embedding for the input text summary; and identifying the training cluster based on an embedding similarity between the input summary embedding and the plurality of training summary embeddings.

Example 16. The computing system of any of examples 13 through 15, wherein generating the candidate prompt for the generative machine learning model comprises identifying one or more prompt training text summaries from the training cluster; and modifying the prompt template to add the one or more prompt training text summaries.

Example 17. The computing system of example 16, wherein the prompt template comprises a few-shot prompt and the one or more prompt training text summaries are added as examples for the few-shot prompt.

Example 18. One or more non-transitory computer-readable storage media including instructions that, when executed by one or more processors, cause the one or more processors to identify a training cluster for an input document; generate a candidate prompt for a generative machine learning model based on the training cluster and a prompt template; provide the candidate prompt to the generative machine learning model to receive at least a portion of a candidate document; generate a plurality of quality metrics for the candidate prompt based on the candidate document; and select the candidate prompt from a plurality of candidate prompts based on the plurality of quality metrics.

Example 19. The one or more non-transitory computer-readable storage media of example 18, wherein the instructions further cause the one or more processors to provide the candidate prompt to the generative machine learning model to receive at least a portion of a predictive document.

Example 20. The one or more non-transitory computer-readable storage media of examples 18 or 19, wherein the at least a portion of the candidate document comprises a candidate text field for a candidate document template corresponding to the candidate document and the instructions further cause the one or more processors to generate, using a hallucination mitigation model, a hallucination mitigated candidate text field from the candidate text field based on a hallucination mitigation prompt; identify the candidate document template for the candidate document; and generate the candidate document by adding the hallucination mitigated candidate text field to the candidate document template.

1. A computer-implemented method comprising:
identifying, by one or more processors, a training cluster for an input document;
generating, by the one or more processors, a candidate prompt for a generative machine learning model based on the training cluster and a prompt template;
providing, by the one or more processors, the candidate prompt to the generative machine learning model to receive at least a portion of a candidate document;
generating, by the one or more processors, a plurality of quality metrics for the candidate prompt based on the candidate document; and
selecting, by the one or more processors, the candidate prompt from a plurality of candidate prompts based on the plurality of quality metrics.

2. The computer-implemented method of claim 1, wherein the training cluster comprises a subset of a plurality of training documents for a prediction domain and the training cluster is previously generated by:
generating, using a large language summarization model, a plurality of training text summaries for the plurality of training documents based on one or more controlled fields for the prediction domain;
generating, using a machine learning embedding model, a plurality of training summary embeddings for the plurality of training text summaries; and
identifying, using a machine learning clustering model, the subset of the plurality of training documents based on the plurality of training summary embeddings.

3. The computer-implemented method of claim 2, wherein identifying the training cluster comprises:
generating, using the large language summarization model, an input text summary for the input document based on the one or more controlled fields for the prediction domain;
generating, using the machine learning embedding model, an input summary embedding for the input text summary; and
identifying the training cluster based on an embedding similarity between the input summary embedding and the plurality of training summary embeddings.

4. The computer-implemented method of claim 1, wherein generating the candidate prompt for the generative machine learning model comprises:
identifying one or more prompt training text summaries from the training cluster; and
modifying the prompt template to add the one or more prompt training text summaries.

5. The computer-implemented method of claim 4, wherein the prompt template comprises a few-shot prompt and the one or more prompt training text summaries are added as examples for the few-shot prompt.

6. The computer-implemented method of claim 1, wherein the prompt template is one of a plurality of prompt templates from a template data store and each of the plurality of candidate prompts correspond to a different prompt template from the plurality of prompt templates.

7. The computer-implemented method of claim 1, wherein the plurality of quality metrics comprises a multi-prompt-based assessment metric, a string-based distance metric, and an embedding-based distance metric, and wherein selecting the candidate prompt from the plurality of candidate prompts comprises:
generating a weighted quality score for the candidate prompt based on the multi-prompt-based assessment metric, the string-based distance metric, and the embedding-based distance metric; and
selecting the candidate prompt based on a comparison between the weighted quality score and a plurality of weighted quality scores corresponding to the plurality of candidate prompts.

8. The computer-implemented method of claim 7, wherein the multi-prompt-based assessment metric is generated by:
generating, using an assessment large language model (LLM), a fluency score for the candidate document based on a fluency prompt, the candidate document, and a training document from the training cluster;
generating, using the assessment LLM, a relevancy score for the candidate document based on a relevancy prompt, the candidate document, and the training document;
generating, using the assessment LLM, an informativeness score for the candidate document based on an informative prompt, the candidate document, and the training document;
generating, using the assessment LLM, a coherency score for the candidate document based on a coherency prompt, the candidate document, and the training document; and
generating the multi-prompt-based assessment metric based on a weighted aggregation of the fluency score, the relevancy score, the informativeness score, and the coherency score.

9. The computer-implemented method of claim 7, wherein the string-based distance metric is generated based on a string comparison between the candidate document and a training document from the training cluster.

10. The computer-implemented method of claim 7, wherein the embedding-based distance metric is generated based on an embedding comparison between the candidate document and a training document from the training cluster.

11. The computer-implemented method of claim 1, wherein the at least a portion of the candidate document comprises a candidate text field for a candidate document template corresponding to the candidate document and the computer-implemented method further comprises:
generating, using a hallucination mitigation model, a hallucination mitigated candidate text field from the candidate text field based on a hallucination mitigation prompt;
identifying the candidate document template for the candidate document; and
generating the candidate document by adding the hallucination mitigated candidate text field to the candidate document template.

12. The computer-implemented method of claim 1, further comprising:
providing the candidate prompt to the generative machine learning model to receive at least a portion of a predictive document.

13. A computing system comprising memory and one or more processors communicatively coupled to the memory, the one or more processors configured to:
identify a training cluster for an input document;
generate a candidate prompt for a generative machine learning model based on the training cluster and a prompt template;
provide the candidate prompt to the generative machine learning model to receive at least a portion of a candidate document;
generate a plurality of quality metrics for the candidate prompt based on the candidate document; and
select the candidate prompt from a plurality of candidate prompts based on the plurality of quality metrics.

14. The computing system of claim 13, wherein the training cluster comprises a subset of a plurality of training documents for a prediction domain and the training cluster is previously generated by:
generating, using a large language summarization model, a plurality of training text summaries for the plurality of training documents based on one or more controlled fields for the prediction domain;
generating, using a machine learning embedding model, a plurality of training summary embeddings for the plurality of training text summaries; and
identifying, using a machine learning clustering model, the subset of the plurality of training documents based on the plurality of training summary embeddings.

15. The computing system of claim 14, wherein identifying the training cluster comprises:
generating, using the large language summarization model, an input text summary for the input document based on the one or more controlled fields for the prediction domain;
generating, using the machine learning embedding model, an input summary embedding for the input text summary; and
identifying the training cluster based on an embedding similarity between the input summary embedding and the plurality of training summary embeddings.

16. The computing system of claim 13, wherein generating the candidate prompt for the generative machine learning model comprises:
identifying one or more prompt training text summaries from the training cluster; and
modifying the prompt template to add the one or more prompt training text summaries.

17. The computing system of claim 16, wherein the prompt template comprises a few-shot prompt and the one or more prompt training text summaries are added as examples for the few-shot prompt.

18. One or more non-transitory computer-readable storage media including instructions that, when executed by one or more processors, cause the one or more processors to:
identify a training cluster for an input document;
generate a candidate prompt for a generative machine learning model based on the training cluster and a prompt template;
provide the candidate prompt to the generative machine learning model to receive at least a portion of a candidate document;
generate a plurality of quality metrics for the candidate prompt based on the candidate document; and
select the candidate prompt from a plurality of candidate prompts based on the plurality of quality metrics.

19. The one or more non-transitory computer-readable storage media of claim 18, wherein the instructions further cause the one or more processors to:
provide the candidate prompt to the generative machine learning model to receive at least a portion of a predictive document.

20. The one or more non-transitory computer-readable storage media of claim 18, wherein the at least a portion of the candidate document comprises a candidate text field for a candidate document template corresponding to the candidate document and the instructions further cause the one or more processors to:
generate, using a hallucination mitigation model, a hallucination mitigated candidate text field from the candidate text field based on a hallucination mitigation prompt;
identify the candidate document template for the candidate document; and
generate the candidate document by adding the hallucination mitigated candidate text field to the candidate document template.
